(19) United States
(12) Patent Application Publication
(10) Pub. No.: US 2002/0138752 A1
(43) Pub. Date: Sep. 26, 2002

(54) Semiconductor integrated circuit and business method therewith

(76) Inventors: Tetsuya Tanaka, Kyoto (JP); Kenichi Kawaguchi, Hyogo (JP)

Correspondence Address: MCDERMOTT, WILL & EMERY, 600 13th Street, N.W., Washington, DC, 20005-3096, US

(21) Appl. No.: 10/060,290

(22) Filed: Feb. 1, 2002

(30) Foreign Application Priority Data
Feb. 2, 2001 (JP) P2001-26930
Jan. 29, 2002 (JP) P2002-19764

(51) Int. Cl. H04L 9/32

(52) U.S. Cl. 713/200

(57) ABSTRACT

At least one function module with use limitation; key information acquisition means for acquiring key information for use permission; a use limitation control means for authenticating the key information mentioned above for use permission, based on use permission information, and for making the use limitation release information valid only when authenticated are provided. A use limitation release signal from the use limitation control means mentioned above usually is inactive, and use of the function module with use limitation is limited. When the key information for use permission is given to the use limitation control means, the use limitation control means authenticates the key information for use permission; the use limitation release signal is made active when authenticated; and use limitation of the function module with use limitation is released. meeting specifications required by a plurality of users, and reasonable balance in paying consideration are realized by installing the function module.

### BACKGROUND OF THE INVENTION

1. Field of the Invention

The present invention relates to a semiconductor integrated circuit (hereinafter, abbreviated to an integrated circuit), and, more specifically, to technologies which meet specifications required by a plurality of users, and realize reasonable balance for consideration sharing. Moreover, the invention relates to a business method with the integrated circuit.

2. Description of the Related Art

Hereinafter, a conventional integrated circuit, and a conventional business system using the integrated circuit will be described.

As shown in FIG. 28, a conventional semiconductor integrated circuit 800 is equipped with a plurality of functional modules 902, 903 such as a timer 0, and a timer 1; and a CPU 900. 901 denotes a memory bus, and 910 is an interrupt request signal. The timer 0 and the timer 1 may be used according to appropriate procedures such as writing data into control registers of the timer 0 and the timer 1, using the CPU 900.

A conventional business system has provided the conventional integrated circuit 800 mentioned above to users, and consideration has been obtained for the integrated circuit 800. Though each user may use all the functions, only functions required by each user have been used.

In a conventional business system, the integrated circuit have installed functional modules (hereinafter, abbreviated to modules) which have been developed based on design information provided from users. In such a case, the integrated circuit has been configured to be provided only to providers of the design information. The integrated circuit equipped with the modules has not been provided to other users.

The conventional business system mentioned above has no configuration which gives limitations to the modules installed in the integrated circuit, and, any modules may be arbitrarily used in the system.

In case that the integrated circuit installing general purpose modules which meet specifications required by a plurality of users is developed and produced, the cost of the integrated circuit tends to be increased because of the general purpose. Users who do not use some of the modules is also affected by the increased cost. However, it is difficult on a commercial base to ask for sharing all the increased costs to users who do not use the certain module(s).

On the other hand, in case that plural kinds of integrated circuits are developed and produced separately from each other according to the difference in the specifications required by the users, the design processes and the production processes become complicated, and load on manufacturers' side becomes heavy.

In case that users who have obtained integrated circuits with certain specifications would like to enhance the functions later, the users have to newly request integrated circuits with different specifications because the desired modules are not installed. The manufacturers are compelled to develop and produce the integrated circuits with new specifications according to the requirements. But, such a case results in high consumption in the cost and the time.

Moreover, there is a problem on a actual commercial base that it is difficult to obtain consideration for the enhanced functions, as, in a conventional business system, the prices of the integrated circuits tends to be kept even for the renewed integrated circuits.

Moreover, it is actually difficult independently to establish individual pricing for every function because the general-purpose-type integrated circuits mentioned above are provided in a state in which all functions installed may be used. There is another problem, in this context as well, that it is difficult to obtain proper consideration for the functions.

Still, the integrated circuits are forced to be provided only to providers of the design information and the know-how, in case that design information and know-how which users have are installed as a module in the integrated circuits. The reason is because there is no means for limiting the use of the modules.

Here, it is assumed that there is an integrated circuit A equipped with a standard module b, in addition to a module a based on the design information provided by the user side. There is no problem when the integrated circuit A is provided to the providers of the design information. On the other hand, it is assumed that there is a user who requires the standard module b mentioned above. The integrated circuit A mentioned above may not be provided to this user. The reason is because the design information on the module a results in being leaked Therefore, an integrated circuit which does not include the module a, and has the module b is required to be newly developed.

However, in such a case, there are a problem that a large amount of development man-hours are required, and a problem that it is difficult to obtain advantages of mass-production, as large-item small-scale production is caused in comparison with a case in which integrated circuits with the same specifications are provided to each user.

### SUMMARY OF THE INVENTION

Thus, the main object of the present invention is to provide a semiconductor integrated circuit which may be produced in a smaller item; and in which some kinds of functions may be provided according to requirements of users at a moderate price; and use of functions that are not required by the users may be limited.

Another object of the present invention is to provide a semiconductor integrated circuit for which use limitation may be removed at an appropriate price when enhanced functions are desired.

In addition, further another object is to provide a business method realizing effective use of the advantages mentioned above.

Other objects, features, and advantages will be come clear by the following description.

The present invention solves the problems mentioned above by the following measures. Modules meeting requirements by each individual user (hereinafter, abbreviated to modules) are installed together in a single integrated circuit, instead of producing plural kinds of integrated circuits installing different modules for every specifications required by users. In this case, all the modules may be not unconditionally used by any users without restraint, but all or a part of modules are installed as a module with use limitation.

That is, the integrated circuit comprises one or a plurality of function modules with use limitation (hereinafter, abbreviated to limited modules) use of which is limited in a state in which a given use limitation release information (hereinafter, abbreviated to release information) represents an invalid state. Such an integrated circuit comprises key information acquisition means and use limitation control means (hereinafter, abbreviated to control means). The key information acquisition means acquires key information for use permission (hereinafter, abbreviated to key information) in order to make the limited module mentioned above valid. The control means performs authentication based on use permission information (hereinafter, abbreviated to permission information) which has held in advance the key information mentioned above given from the key information acquisition means mentioned above. And then, only when authenticated, that is, only when the key information is in agreement with the permission information, the release information mentioned above is made valid, and given to the limited module mentioned above, and use of the limited module is permitted. The key information acquisition means and the use limitation control means may be configured using hardware, software, or a combination of the hardware and the software.

According to this configuration, the limited module is usually in an invalid state as the release information represents an invalid state, and the use is inhibited. The user requesting for use of the limited module gives the key information to the integrated circuit according to some procedures. The key information acquisition means acquires the key information, and gives it to the control means. The control means verifies the key information, using the permission information, which has been held in advance, as a comparison standard. Then, the release information is made valid, and given to the limited module when in agreement with each other. The use limitation state of the limited module, to which valid release information is given, is released, and the user can use the limited module.

When there are a plurality of required specifications by users of the integrated circuit to cause different modules, a manufacturer of the integrated circuit installs plural kinds of modules, which are assumed in advance, in one integrated circuit together. It is achieved that all the installed modules may not be used by all the users.

The side of providers of the integrated circuit may confirm that key information is provided upon requests from a user who wants to use limited modules. This does not depend on whether modules with standard specifications, which all users are equally permitted to use, are installed or not. Moreover, this does not depend on whether the number of limited modules which are installed is one or more. Based on this confirmation, the side of providers may easily and reliably control consideration, which is shared by users.

Alternately, it is easily to control the following permission, though key information, substituting for the consideration which is shared by users, is provided at a free or low price to users who have provided design information on the modules with a limitation, and use of the key information is permitted. Use of the limited modules may be inhibited by not providing the key information to other users.

Plural kinds of modules which meet separate user requests are installed together, and some of modules, if required, are installed as a module with use limitation. As plural kinds of modules are installed together, small-item production of integrated circuits to be produced may be performed, and development, design, and production may be made simpler.

In case that one kind of modules are provided to a plurality of users who have different requests respectively, functions are provided to the users according to the requests, and appropriate consideration may be obtained for the functions. That is, the consideration for functions required by the users may be obtained, and use of functions not required by the users may be limited.

Moreover, there may be further development in which the key information is provided, and use limitation of the limited module is released in case that the users require function enhancement. As shown above, the function enhancement becomes possible without changing the integrated circuit, and consideration for the function enhancement may be obtained as consideration for the key information.

Preferable aspects of the control means mentioned above in the above description may be listed as follows. That is, a key information holding means for holding the key information mentioned above, and authentication means by which authentication of the key information mentioned above, which has been held in the key information holding means mentioned above, is performed based on permission information which has been established in advance, and the release information mentioned above is made valid only when authenticated are provided. The key information holding means, and authentication means may be configured using hardware, software, or a combination of the hardware and the software.

In this case, the key information holding means holds the key information which the key information acquisition means acquired, and, then, sends the key information to the authentication means. The authentication means compares the received key information with the permission information as a comparison standard to perform authentication. When it is authenticated that the key information is the pertinent key information, the release information is assumed to be valid.

In addition, it is a preferable aspect of the key information acquisition means mentioned above in the above description, that a processing in which a central processing unit generate the key information mentioned above according to programs, and the generated key information is given to the control means mentioned above.

According to another preferable aspect, the key information acquisition means mentioned above includes an external terminal into which the key information mentioned above can be input from the outside. At construction of a system, the key information is established by fixing the external terminal at a predetermined potential (VDD, GND, and the like). Then, the central processing unit loads the state of the external terminal at use of the system, and the key information is given to the control means.

Moreover, as another aspect, the key information acquisition means mentioned above includes in some cases a nonvolatile memory which holds the key information mentioned above. In this case, there is no need at restart to acquire the key information because the key information is held even if the power supply is cut, and thereby, the load may be reduced.

The nonvolatile memory mentioned above may be configured as follows. That is, an information input terminal into which the key information mentioned above is written from the outside is attached. The written key information is read out by the central processing unit, and given to the control means mentioned above.

In addition, the nonvolatile memory mentioned above may be configured as follows. That is, the key information mentioned above into which the central processing unit has generated according to programs is written. The written key information is read out by the central processing unit mentioned above, and given to the control means mentioned above.

There is another preferable aspect of the key information acquisition means mentioned above as follows. That is, a register which stores the key information mentioned above which has been generated by the central processing unit according to programs is included. The central processing unit mentioned above reads out the key information mentioned above from the register mentioned above according to programs. The key information mentioned above which has been read out is given to the control means mentioned above.

Furthermore, further another preferable aspect of the key information acquisition means mentioned above may be listed as follows. That is, information receiving means for receiving the key information mentioned above, which is given from the outside through electromagnetic waves; a demodulation means for demodulating the key information mentioned above which the information receiving means mentioned above has received; and a register holding the key information mentioned above which the demodulation means mentioned above has demodulated are included. In this case, there is an advantage in prevention of illegal acquisition of the key information.

Also, another preferable aspect of the key information acquisition means mentioned above is to include a decoding means for decoding of the key information mentioned above which has been enciphered. In this case, there is also an advantage in prevention of illegal acquisition of the key information.

A preferable aspect of the control means mentioned above in the above description may be listed as follows. That is, a logic circuit corresponding to the permission information mentioned above with a N-bit length is included. The output of the logic circuit mentioned above at input of the key information mentioned above with a N-bit length into the logic circuit mentioned above is assumed to be the release information mentioned above. The logic circuit may be configured to be as a combinational circuit, or as a sequential circuit.

A preferable aspect of the limited module mentioned above in the above description may be listed as follows. That is, a use limitation/release means (hereinafter, abbreviated to limitation/release means), which may be controlled by the key information mentioned above given from the control means mentioned above, and switch an invalid state to a valid state, is attached. The limitation/release means is usually in a use limitation state, and when the key information representing a valid state is given, the use limitation state is switched to a state in which the use limitation is released.

And, a preferable aspect of the limitation/release means mentioned above is means by which a control signal, or data which are input to the limited module mentioned above are made invalid.

Moreover, another preferable aspect of the limitation/release means mentioned above is means by which a control signal, or data which the limited module mentioned above outputs are made in invalid.

Furthermore, another preferable aspect of the limitation/release means mentioned above is means by which power supply to the limited module mentioned above is limited. In this case, there is an advantage that the power consumption of the module with use limitation is reduced, too.

In addition, another preferable aspect of the limitation/release means mentioned above is means by which clock supply to the limited module mentioned above is limited. The use of the limited module is inhibited by clock stopping or reduced clock speed.

A preferable aspect of the control means in the above description may be listed as follows. That is, there is required idling time during the following authentication, though it is authenticated whether the release information mentioned above is made valid or not when the key information mentioned above is given from the key information acquisition means mentioned above. It is assumed that the key information is illegally acquired by repeating illegal release trials and by specification of the key information mentioned above. In this case, there is an advantage that illegal release is made actually impossible by making the repeating time longer one.

In addition, a preferable aspect of the limitation/release means mentioned above may be listed as follows. That is, the limited module mentioned above is made valid, when the release information mentioned above is given from the control means mentioned above. It is required in this processing that there is required idling time. In this case, there is an advantage that illegal release is made actually impossible by making the repeating time longer one.

Here, a timer circuit; a clock generation circuit; a clock switching circuit; a debugging circuit; a memory; and the like may be used as the limited module mentioned above. Or, arbitrary combinations of the items mentioned above may be used.

Then, a business method with the integrated circuit having the configuration mentioned above will be described.

A business method with the integrated circuit according to the present invention which has an object to solve the problem mentioned above includes at least the following steps:

a step of providing a semiconductor integrated circuit installing at least one limited module to a user (S01);

a step of giving use permission of key information, which is corresponding to the limited module mentioned above, to the user mentioned above(S02);

a step of releasing use limitation of the limited module, which is corresponding to the key information mentioned above, using the key information mentioned above to which the use permission mentioned above is given (S03); and

a step of obtaining consideration for the use permission of the key information mentioned above from the user mentioned above(S04).

This is a case in which the key information corresponding to a limited module based on use request is provided to a user, when there is the use request of the limited module mentioned above from the user to which an integrated circuit has been provided. Or, there is another case in which key information itself has been built-in, in advance, in the integrated circuit, and actual use is permitted. Consideration is requested to the user as a return for use permission of the key information. Pecuniary resources; properties; services; and the like, or any other things may be used as the consideration.

The same time at which the integrated circuit is provided, or time at which there is a request from the user after provision may be used as time at which the use permission of the key information is given. Appropriate time, such as when the key information is provided; when use permission is made; and when use limitation is actually released, may be set as time when the consideration is obtained, considering business practice.

Preferable aspects in the business method with the integrated circuit mentioned above may be listed as follows:

Ones comprising the following components are an object of the integrated circuit mentioned above. That is, at least one limited module use of which is limited as the release information represents an invalid state; and a key information acquisition means for acquiring the key information to make the limited module mentioned above valid. In addition, further another one is control means for use permission by authentication of the key information mentioned above given from the key information acquisition means mentioned above based on the permission information which has been held in advance; by making the release information mentioned above valid only when authenticated, and by giving the valid use limitation release information mentioned above to the limited module mentioned above.

Moreover, the control means mentioned above authenticates the key information mentioned above at the step of releasing the use limitation mentioned above, after the key information acquisition means mentioned above acquires the key information mentioned above. Then, the release information mentioned above is made valid, and given to the limited module mentioned above only when authenticated, and the use is permitted.

Each function, which includes at least the following functions, has been installed, in advance, in the pertinent integrated circuit: acquisition of the key information into the circuit; authentication of the key information; making the release information valid; and use permission of the limited module.

Further, another aspect of the present invention solves the problems mentioned above by the following measures. That is, at least the following steps are included:

a step of providing the integrated circuit installing plural kinds of limited modules (S11);

a step of giving use permission of the key information, which is corresponding to at least any one of the plural kinds of limited module mentioned above, to the user mentioned above(S12);

a step of releasing use limitation of at least one limited module corresponding to key information using at least one key information to which the use permission mentioned above is given to (S13); and

a step of obtaining consideration for use permission of the key information mentioned above from the user mentioned above(S14).

Here, it is specified that the limited module which has been installed are of plural kinds. Use permission may be given to all or a part of limited modules.

One aspect in the business method mentioned above may be described as follows. That is, at a step of giving use permission of the key information mentioned above, use permission of plural kinds of key information corresponding to plural kinds of limited modules is given. In addition, at a step of releasing the use limitation mentioned above, use limitation of plural kinds of limited modules corresponding respectively to these plural pieces of key information is released, using plural pieces of key information to which the use permission mentioned above is given. Then, at a step of obtaining the consideration mentioned above, consideration for the use permission of the plural key information mentioned above is obtained. This specifies that the number of the key information which gives use permission is temporarily plural.

Moreover, another aspect of the present invention includes at least the following steps:

a step of obtaining from a user design information on a module to be installed in the integrated circuit (S21);

a step of providing to the user mentioned above the integrated circuit mentioned above installing at least one module with use limitation based on the obtained design information mentioned above(S22);

a step of giving to the user mentioned above use permission of key information, which is corresponding to the limited module mentioned above(S23); and

a step of releasing use limitation of the limited module mentioned above, which is corresponding to the key information mentioned above, using the key information mentioned above to which the use permission mentioned above is given (S24).

This provides key information to the user mentioned above (provider of design information) as a return when design information (operation algorithm, architecture, design know-how and the like) is provided from the side of the user. Or, the key information itself has been built-in, in advance, in the integrated circuit, and actual use is permitted. In this case, the permission may be performed at a free or low price.

Furthermore, another aspect of the present invention includes at least the following steps:

a step of obtaining from the first user design information on the module to be installed in the integrated circuit (S31);

a step of obtaining from the second user design information on another module different from the module mentioned above to be installed in the integrated circuit (S32);

a step of providing to the first user mentioned above the integrated circuit mentioned above installing plural kinds of limited modules, based on each design information which has been obtained from the first and the second users mentioned above(S33);

a step of providing to the second user mentioned above an integrated circuit with the same specifications with that of the integrated circuit mentioned above(S34);

a step of giving use permission of the first key information, which is corresponding to the limited module mentioned above based on design information from the first user mentioned above, to the first user mentioned above(S35).

a step of releasing use limitation of the limited module mentioned above, which is corresponding to the first key information mentioned above, using the first key information mentioned above to which the use permission mentioned above is given in the first user mentioned above(S36);

a step of giving use permission of the second key information, which is corresponding to the limited module mentioned above based on design information from the second user mentioned above, to the second user mentioned above(S37); and

a step of releasing use limitation of the limited module mentioned above, which is corresponding to the second key information mentioned above, using the second key information mentioned above to which the use permission mentioned above is given in the second user mentioned above(S38).

In the above description, (S31) and (S32) do not represent an order relation such as before and after. The relation between (S33) and (S34) is also similar to the relation between (S35) and (S37).

This means that, with regard to the first user, use of the second limited module, for which the design information has not been received from the first user, is limited, though use of the first limited module for which the design information has been provided by the first user is permitted. And, with regard to the second user, use of the first limited module, for which the design information has not been received from the second user, is limited, though use of the second limited module for which the design information has been provided by the second user is permitted. In short, the use among a plurality of users mentioned above is exclusive.

The present invention is effective for application to electronic commerce with a semiconductor integrated circuit performed between a computer at the side of a provider, and computers at the side of users through a communications line. The one aspect includes the steps of: transmitting key information for use permission, which is corresponding to a functional module with use limitation, from the computer mentioned above at the side of the provider mentioned above to the computer mentioned above at the side of the user mentioned above through the communications line mentioned above; and receiving the payment information mentioned above by the computer mentioned above at the side of the provider mentioned above, when payment information for use of the key information mentioned above for use permission at the side of the user mentioned above is transmitted from the computer mentioned above at the side of the user mentioned above to the communications line mentioned above. In this case, any type of aspects may be acceptable for provision of the semiconductor integrated circuit itself to the side of the user, and for the release of the use limitation of the functional module with use limitation.

In the invention with the electronic commerce mentioned above, transmission of payment information from the computer mentioned above at the side of the user mentioned above to the computer mentioned above at the side of the provider mentioned above may be preferably performed through a financial institution computer connected to the communications line mentioned above. However, the electronic settlement may be directly performed not through the financial institution computer.

Another aspect of the electronic commerce includes the steps of: receiving the design information mentioned above at the computer mentioned above at the side of the provider mentioned above, when design information on the functional module to be installed in the semiconductor integrated circuit mentioned above is transmitted from the computer mentioned above at the side of the user mentioned above to the computer mentioned above at the side of the provider through the communications line mentioned above; and transmitting key information for use permission, which is corresponding to a functional module with use limitation based on the design information mentioned above, from the computer mentioned above at the side of the provider mentioned above to the computer mentioned above at the side of the user mentioned above through the communications line mentioned above.

In any of the business methods mentioned above with the integrated circuits mentioned above, the following configuration may be preferable. At least one limited module use of which is limited in a state in which release information is invalid; and key information acquisition means for acquiring key information in order to make the limited module mentioned above valid are comprised. Use limitation control means is further comprised. This control means authenticates the key information mentioned above given from the key information acquisition means mentioned above based on the permission information which has been held in advance. Then, the release information mentioned above is made valid, and given to the limited module mentioned above only when authenticated, and the use is permitted. The integrated circuits mentioned above are an object of the present invention. Then, at a step of releasing the use limitation mentioned above, the control means mentioned above authenticates the key information mentioned above, after the key information acquisition means mentioned above acquires the key information mentioned above. The release information mentioned above is made valid, and given to the module mentioned above only when authenticated, and, thereby, the use is permitted.

### BRIEF DESCRIPTION OF THE DRAWINGS

These and other objects as well as advantages of the invention will become clear by the following description of preferred embodiments of the invention with reference to the accompanying drawings, wherein:

FIG. 1 is a block diagram showing a schematic configuration of an integrated circuit according to a first embodiment of the present invention;

FIG. 2 is a block diagram of a use limitation control circuit according to the first embodiment;

FIG. 3 is an explanatory view of a configuration of a register for a timer according to the first embodiment;

FIG. 4 is a block diagram of a second timer according to the first embodiment;

FIG. 5 is a block diagram showing a schematic configuration of an integrated circuit according to a second embodiment of the present invention.

FIG. 6 is a block diagram showing a schematic configuration of an integrated circuit according to a third embodiment of the present invention.

FIG. 7 is a block diagram showing a schematic configuration of an integrated circuit according to a fourth embodiment of the present invention.

FIG. 8 is a block diagram showing a schematic configuration of an integrated circuit according to a fifth embodiment of the present invention;

FIG. 9A is a conceptual view of an authentication circuit according to a sixth embodiment of the present invention;

FIG. 9B is a concrete circuit configuration view of an authentication circuit according to the sixth embodiment;

FIG. 9C is a truth table for the authentication circuit according to the sixth embodiment;

FIG. 10 is a block diagram showing a schematic configuration of an integrated circuit according to the seventh embodiment of the present invention;

FIG. 11 is a block diagram showing a schematic configuration of an integrated circuit according to the eighth embodiment of the present invention;

FIG. 12 is a block diagram of a use limitation control circuit according to the eighth embodiment;

FIG. 13 is a block diagram showing a schematic configuration of an integrated circuit according to a ninth embodiment of the present invention;

FIG. 14 is a block diagram of a clock switching circuit according to a tenth embodiment of the present invention;

FIG. 15 is a block diagram showing a schematic configuration of an integrated circuit according to an eleventh embodiment of the present invention;

FIG. 16 is a block diagram showing a schematic configuration of an integrated circuit according to a twelfth embodiment of the present invention;

FIG. 17 is a block diagram showing a schematic configuration of an integrated circuit according to a thirteenth embodiment of the present invention;

FIG. 18 is a block diagram showing a configuration of a use limitation control circuit according to a fourteenth embodiment of the present invention;

FIG. 19 is a block diagram showing a configuration of a use limitation control circuit according to a fifteenth embodiment of the present invention;

FIG. 20 is a block diagram showing a schematic configuration of an integrated circuit according to a sixteenth embodiment of the present invention;

FIG. 21 is a block diagram showing a schematic configuration of an integrated circuit according to a seventeenth embodiment of the present invention;

FIG. 22 is an explanatory view of a cutting example of a semiconductor wafer according to an eighteenth embodiment ;

FIG. 23 is a view of a system configuration for a business system according to a nineteenth embodiment of the present invention;

FIG. 24 is a view of a system configuration for a business system according to a twentieth embodiment of the present invention;

FIG. 25 is a view of a system configuration for a business system according to a twenty-first embodiment of the present invention;

FIG. 26 is a view of a system configuration for a business system according to a twenty-second embodiment of the present invention;

FIG. 27 is a view of a system configuration for a business system according to a twenty-third embodiment of the present invention;

FIG. 28 is a schematic block diagram of a conventional integrated circuit.

In all these figures, like components are indicated by the same numerals.

### DETAILED DESCRIPTION OF THE PREFERRED EMBODIMENTS

Hereinafter, preferred embodiments of an integrated circuit according to the present invention will be described, referring to accompanying drawings.

(First Embodiment)

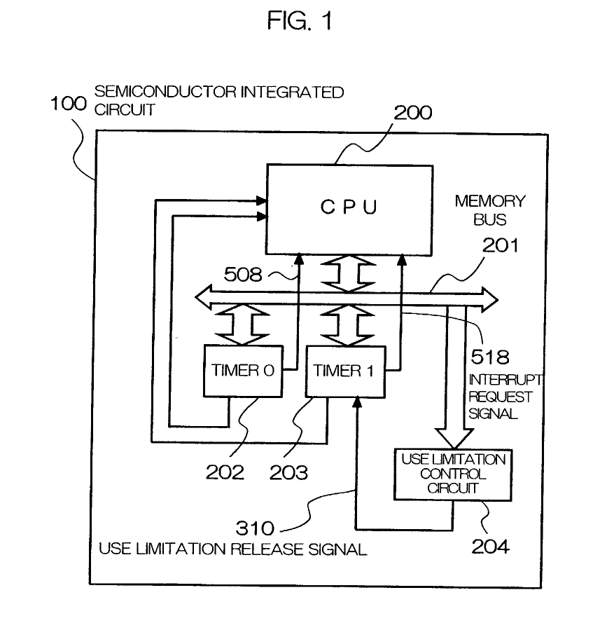

FIG. 1 is a block diagram showing a schematic configuration of the integrated circuit according to a preferred first embodiment of the present invention. 100 is the integrated circuit; 200 is a CPU (central processing unit); 201 is a memory bus; 202 is a first timer; 203 is a second timer; and 204 is a use limitation control circuit (hereinafter, abbreviated to a control circuit).

In the integrated circuit 100, any user may use the first timer 202. With regard to the second timer 203, only users who are permitted to use the timer 203 are allowed to use it. That is, the second timer 203 is one example of a limited module. The control circuit 204 controls whether use permission is given or not.

The CPU 200 operates according to programs read from a main memory which is not shown in the drawing, and connected to the memory bus 201. The CPU 200 starts the first timer 202 through the memory bus 201. The first timer 202 makes count down, and an interrupt request signal 508 is sent to the CPU 200, when a counted value reaches “0”.

The second timer 203 can be used, only when a use limitation release signal 310 (hereinafter, abbreviated to a release signal) represents a use permission state after completion of authentication for use permission in the control circuit 204. Though the use permission state of the release signal 310 may be represented by any of a level “1”, or a level “0”, it is assumed here that the level “1” represents the use permission state.

The CPU 200 starts the timer 203. When the timer 203 represents the use permission state, the count down is actually made, and the timer 203 sends an interrupt request signal 518 to the CPU 200 when the counted value reaches “0”.

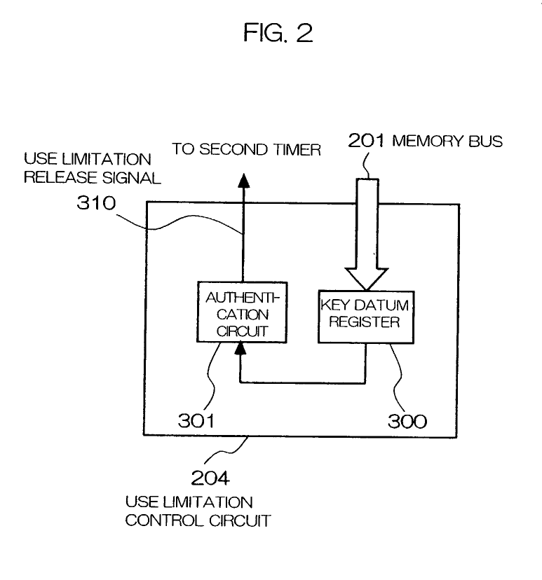

FIG. 2 is a block diagram showing the inside of the control circuit 204. 300 is a key datum register as key information holding means, and 301 is an authentication circuit. The key datum register 300 holds a key datum for use permission which is sent from the memory bus 201, and the key datum for use permission is sent to the authentication circuit 301. The authentication circuit 301 has held in advance secret permission information as a comparison standard datum. The key datum from the key datum register 300 is compared with the permission information, and the release signal 310 is left in the level “0” state representing no use state in the case of disagreement, and the release signal 310 is switched only in the case of agreement to the level “1” to give use permission to the timer 203. The key datum register 300 corresponds to the key information holding means and the authentication circuit 301 corresponds to the authentication means.

Key information acquisition means according to the present embodiment corresponds to processing in which the CPU 200 generates a key datum according to programs read from the main memory which is not shown in the drawing, and gives the generated key datum to the key datum register 300 through the memory bus 201.

The authentication circuit 301 in the control circuit 204 is at shipment initialized into a state where “0” representing no use is output as the release signal 310. The timer 203 into which “O” has been input as a release signal 310 is in an invalid state. Therefore, the timer 203 may not be made operable even when the CPU 200 tries to operate the timer 203. That is, the timer 203 is in the no-use state.

Users using the pertinent integrated circuit 100 perform processing by which the timer 203 is made valid, when it is required to be used. Thereby, the CPU 200 makes the timer 203 valid using the key datum which has been generated according to required programs in the not-shown main memory. Description will be concretely made as follows;

With regard to the integrated circuit 100 for users who are permitted to use the timer 203, the manufacturer side has installed in advance the key datum in the main memory (not shown) connected to the memory bus 201 at shipment of the integrated circuit 100. At the user side who has received the integrated circuit 100, the CPU 200 fetches the key datum from the main memory mentioned above into the memory bus 201, and transfers the key datum to the key datum register 300 in the control circuit 204 for storage therein. the key datum register 300 gives the stored key datum to the authentication circuit 301.

The authentication circuit 301 compares the given key datum with the permission information which is the comparison standard datum, and has been held in advance; and decides whether they are in agreement or not. In the case of disagreement, the release signal 310 is left as “0”. In this case, the timer 203 is left yet in the no-use state. This is effective for prevention of illegal use.

When the given key datum is in agreement with the permission information, the authentication circuit 301 sends the release signal 310 of “1” representing the use permission to the timer 203. Thereby, the timer 203 is made valid.

When the CPU 200 operates the timer 203 under the state in which the timer 203 is made valid, the operation becomes possible. That is, the timer 203 is in a state in which the timer can be used. Though the operation depends on the type of the timer, for example, the CPU 200 writes the datum of the initial counted value into the timer 203 through the memory bus 201; the timer 203 starts timer-counting operation and returns the interrupt request signal 518 to the CPU 200 when the counted value reaches “0”.

Hereinafter, one specific example of the timer 203 will be described, though any configuration may be acceptable as the timer 203 as a limited module which is an option object, considering the spirit of the present invention.

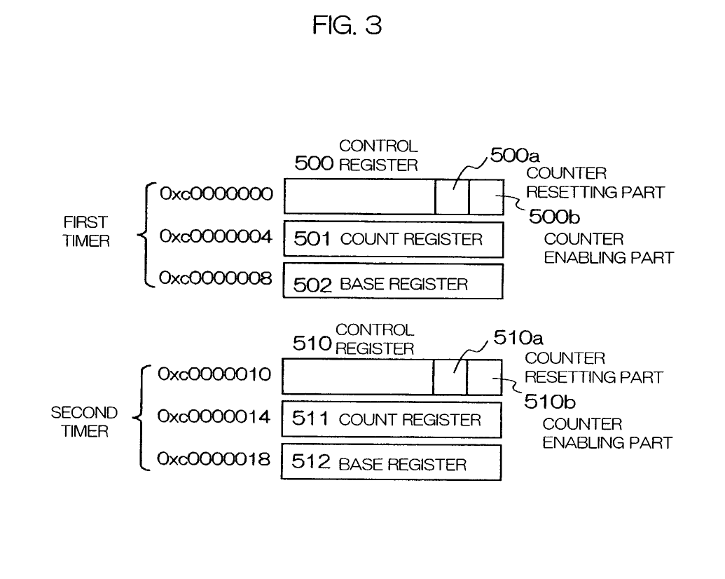

FIG. 3 is an explanatory view of a configuration of a register with which the timer is provided. The first timer 202 comprises: a control register 500; a count register 501; and a base register 502. And, the second timer 203 also comprises in a similar manner: a control register 510; a count register 511; and a base register 512. Each of the components mentioned above is connected to the memory bus 201, and the CPU 200 is accessible to each of them. Here, “0xc0000000”, “0xc0000018”, and the like represent addresses by which the CPU 200 accesses to each register. The control registers 500, 510 are provided with count resetting parts 500a, 510a, and count enabling parts 500b, 510b, respectively.

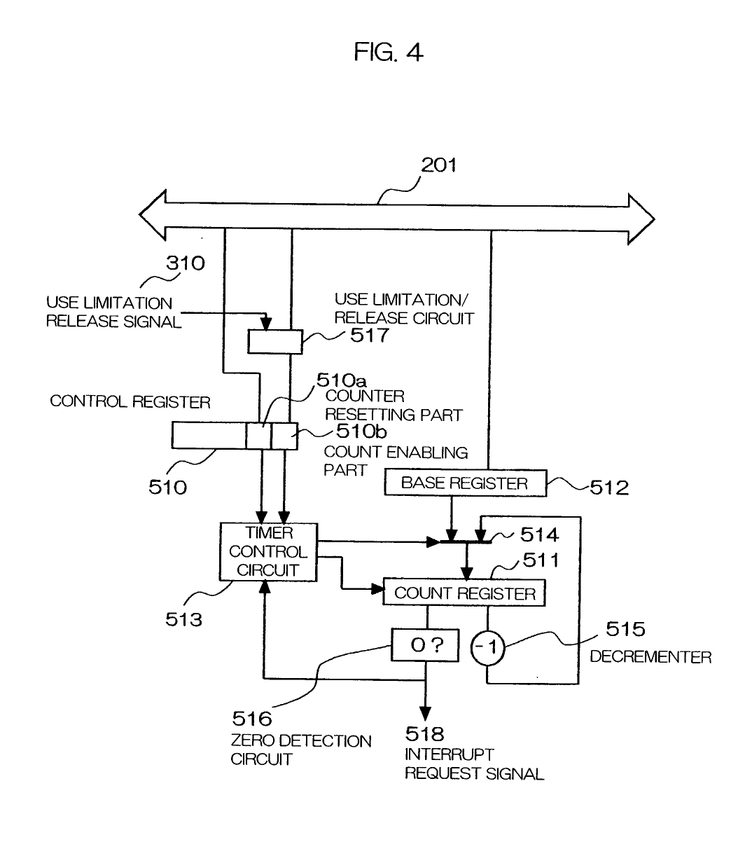

FIG. 4 is a block diagram showing a detailed configuration of the second timer 203. The second timer 203 further comprises, as well as the control register 510, count register 511, and base register 512 mentioned above: a timer control circuit 513; a selector 514; a decrementer 515; and a zero detection circuit 516, and still further includes a use limitation/release circuit 517. The use limitation/release circuit 517 corresponds to the limitation/release means, and, for example, comprises a gate circuit. Here, the first timer 202 has a similar configuration, though the use limitation/release circuit 517 which is controlled by the release signal 310 is not provided.

Hereinafter, the operation of the timer 203 will be briefly described.

In the first place, the CPU 200 establishes the initial counted value in the base register 512 through the memory bus 201.

Then, the CPU 200 writes “1” into the count resetting parts 510a in the control register 510 through the memory bus 201. Thereby, the timer control circuit 513 controls the selector 514, and copies the initial counted value, which has been established in the base register 512, into the count register 511.

Subsequently, the CPU 200 performs writing processing of “1” into the count enabling part 510b in the control register 500 from the memory bus 201 through the use limitation/release circuit 517. At this time, the use limitation/release circuit 517 is in a gate-off state, and writing of “1” is inhibited, when the release signal 310 represents “0”. However, the use limitation/release circuit 517 is in a gate-on state, and “1” may be written into the count enabling part 510b from the memory bus 201 through the use limitation/release circuit 517, when the release signal 310 is switched to “1”.

When “1” is written into the count enabling part 510b, the timer control circuit 513 switches the selector 514 to the side of the decrementer 515, and, at the same time, the count register 511 is controlled to perform the count-down operation. That is, the value established in the count register 511 is decreased by one every cycle with the decrementer 515. The zero detection circuit 516 makes the interrupt request signal 518 active to request for interruption to the CPU 2000 when the circuit 516 detects that the value of the count register 511 becomes “0”. At the same time, the interrupt request signal 518 resets the timer control circuit 513 to terminate the counting operation.

(Second Embodiment)

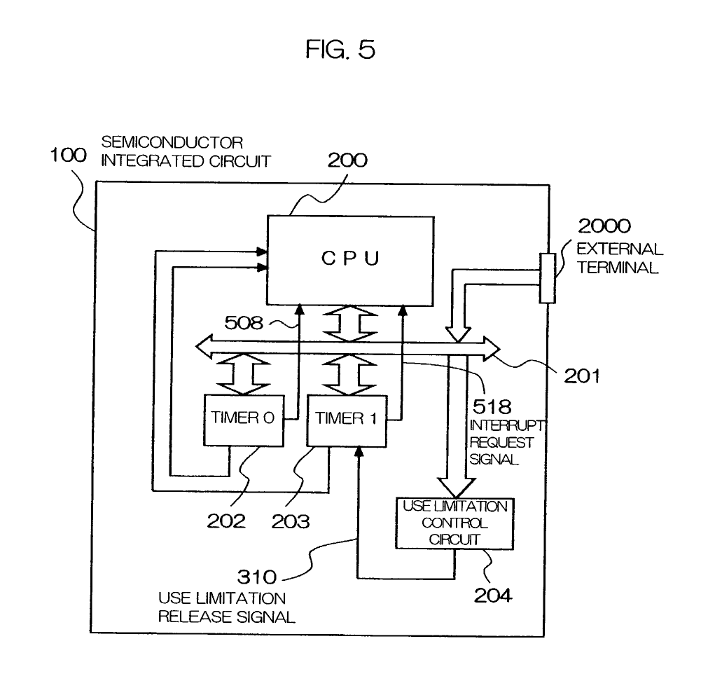

FIG. 5 is a block diagram showing a configuration of an integrated circuit according to a second embodiment of the present invention. An integrated circuit 100 is provided with an external terminal 2000 for a plurality of bits with which a key datum for use permission can be established. The external terminal 2000 is connected to a memory bus 201. As other parts of the configuration are similar to those of FIG. 1, similar parts are denoted by the same reference numerals as those in FIG. 1, and description will be eliminated. Moreover, the configurations of FIG. 2, FIG. 3, and FIG. 4 are applied to the present embodiment.

A user who wants to use a timer 203 gets the pertinent integrated circuit 100, and, at the same time, receives a key datum provided by a provider. When the user constructs a device, using the integrated circuit 100, a key datum, according to the received key datum mentioned above, is established in the integrated circuit 100 by fixing pertinent bits of the external terminal 2000 to a predetermined electric potential (for example, ground GND).

When the circuit 100 is used, the CPU 200 acquires the key datum established in the external terminal 2000 through the memory bus 201; and transfers the key datum to the key datum register 300 in the control circuit 204, and stores the key datum therein.

The function mentioned above corresponds to “key information acquisition means” defined in the claims. As other parts of the configuration and other operations are similar to those of the first embodiment, the description will be eliminated.

(Third Embodiment)

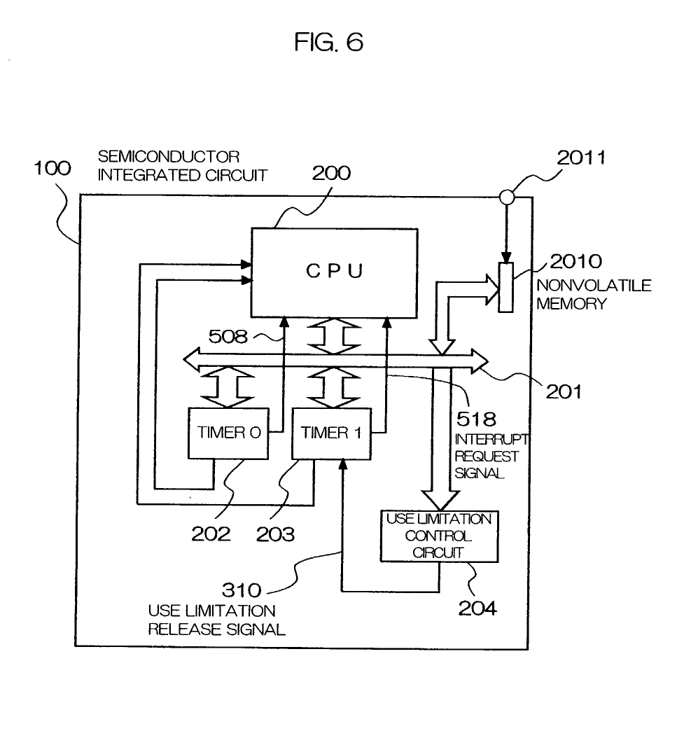

FIG. 6 is a block diagram showing a configuration of an integrated circuit according to a third embodiment. An integrated circuit 100 comprises; a nonvolatile memory 2010 which can store a key datum for use permission; and a key-datum input terminal 2011. The nonvolatile memory 2010 is connected to a memory bus 201 and the key-datum input terminal 2011. As other parts of the configuration are similar to those of FIG. 1, similar parts are denoted by the same reference numerals as those in FIG. 1, and description will be eliminated. Moreover, the configurations of FIG. 2, FIG. 3, and FIG. 4 are applied to the present embodiment.

According to a request of a user who wants to use a timer 203, the manufacturer side writes the key datum (serial datum) into the nonvolatile memory 2010 from the key datum input terminal 2011 at shipment of the integrated circuit 100. The integrated circuit 100 into which the key datum has been written is provided to the user.

When the circuit 100 is used, the CPU 200 acquires the key datum by access to the nonvolatile memory 2010 through the memory bus 201; and transfers the key datum to the key datum register 300 in the control circuit 204, and stores the key datum therein.

As the key datum is always held in the integrated circuit 100, release processing of use limitation of the timer 203 is performed at high speed in a state in which the load of the CPU 200 is reduced.

The function mentioned above corresponds to “key information acquisition means” defined in the claims. As other parts of the configuration and other operations are similar to those of the first embodiment, the description will be eliminated.

In addition, it may be also considered that the nonvolatile memory 2010 is eliminated, and the key datum register 300 in the control circuit 204 is configured as a nonvolatile memory, instead of the eliminated memory 2010.

(Fourth Embodiment)

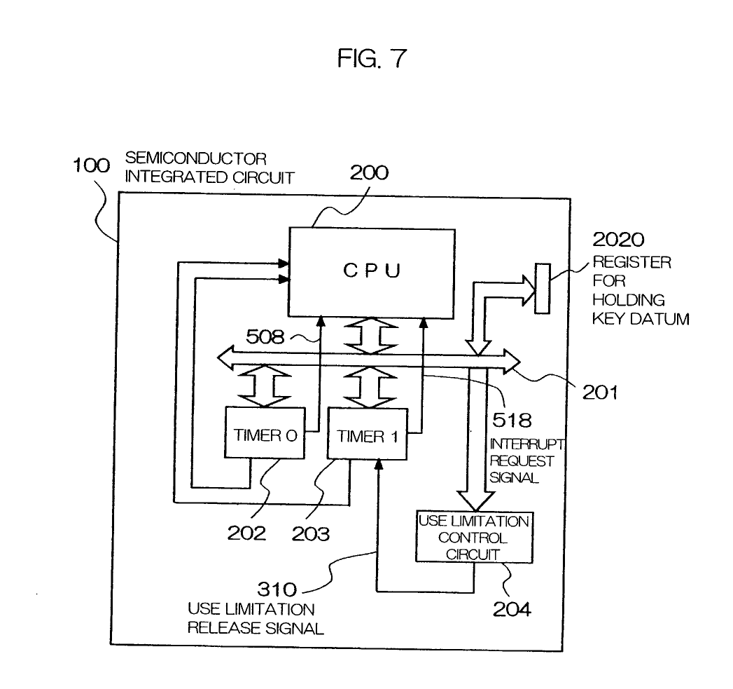

FIG. 7 is a block diagram showing a configuration of an integrated circuit according to a fourth embodiment. An integrated circuit 100 comprises; a register for holding a key datum 2020 which can store a key datum for use permission. The register -for holding a key datum 2020 is connected to a memory bus 201. As other parts of the configuration are similar to those of FIG. 1, similar parts are denoted by the same reference numerals as those in FIG. 1, and description will be eliminated. Moreover, the configurations of FIG. 2, FIG. 3, and FIG. 4 are applied to the present embodiment.

At power-on, the CPU 200 writes key datum into the register for holding a key datum 2020 after generating the key datum according to programs. Then, when the circuit 100 is used, the CPU 200 reads the key datum from the register for holding a key datum 2020 according to programs, and transfers the key datum to the key datum register 300 in the control circuit 204, and stores the key datum therein.

As the key datum are always held in the integrated circuit 100, release processing of use limitation of the timer 203 is performed at high speed in a state in which the load of the CPU 200 is reduced.

The function mentioned above corresponds to “key information acquisitionmeans” defined in the claims. As other parts of the configuration and other operations are similar to those of the first embodiment, the description will be eliminated.

(Fifth Embodiment)

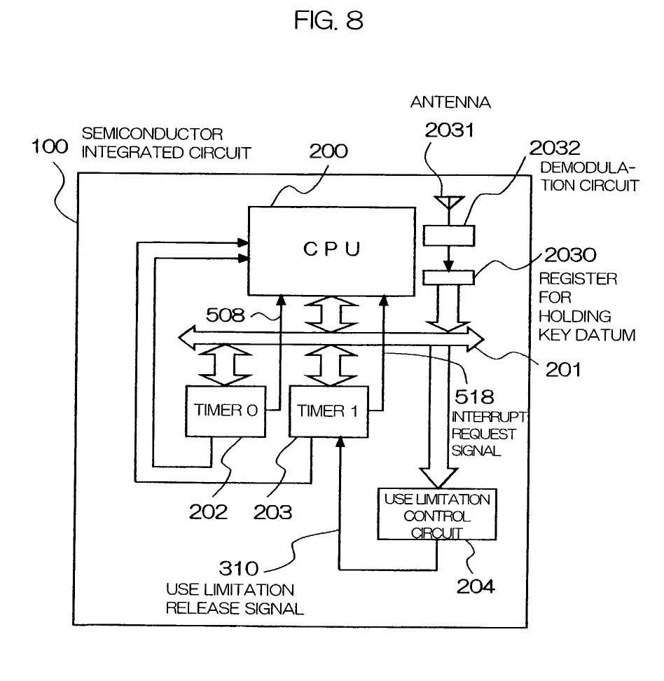

FIG. 8 is a block diagram showing a configuration of an integrated circuit according to a fifth embodiment. An integrated circuit 100 comprises: an antenna 2031 as information receiving means for receiving a key datum for use permission given from the outside through electromagnetic waves; a demodulation circuit 2032 which demodulates the key datum received by the antenna 2031; and a register for holding a key datum 2030 which stores the recovered key datum. The register for holding a key datum 2030 is connected a memory bus 201. As other parts of the configuration are similar to those of FIG. 1, similar parts are denoted by the same reference numerals as those in FIG. 1, and description will be eliminated. Moreover, the configurations of FIG. 2, FIG. 3, and FIG. 4 are applied to the present embodiment.

The antenna 2031 receives the electromagnetic waves, including the key datum, which have propagated from the outside; the demodulation circuit 2032 converts the received electromagnetic waves into the key datum in the form of a digital signal; and the converted key datum are written into the register 2030 for holding a key datum. Then, when the circuit 100 is used, a CPU 200 reads the key datum from the register for holding a key datum 2030 according to programs, and transfers the key datum to a key datum register 300 in a control circuit 204, and stores the key datum therein.

The function mentioned above corresponds to “key information acquisition means” defined in the claims. As other parts of the configuration and other operations are similar to those of the first embodiment, the description will be eliminated.

(Sixth Embodiment)

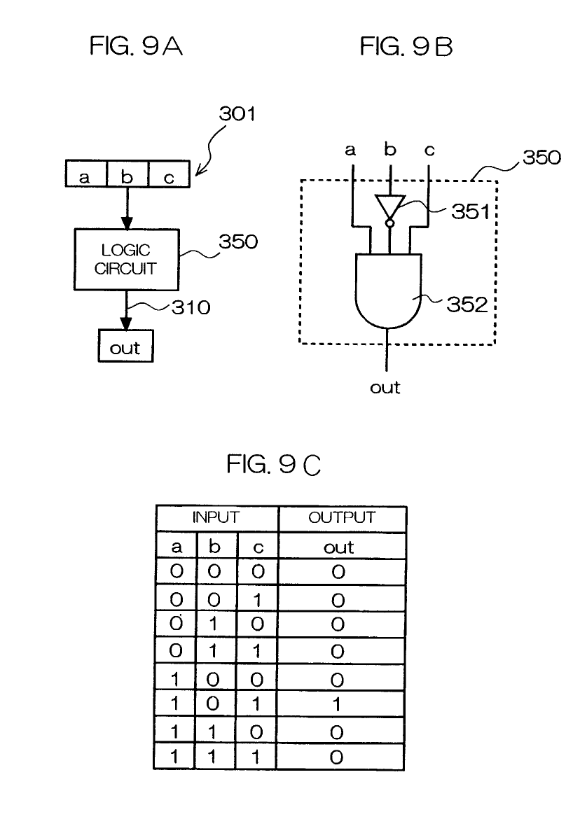

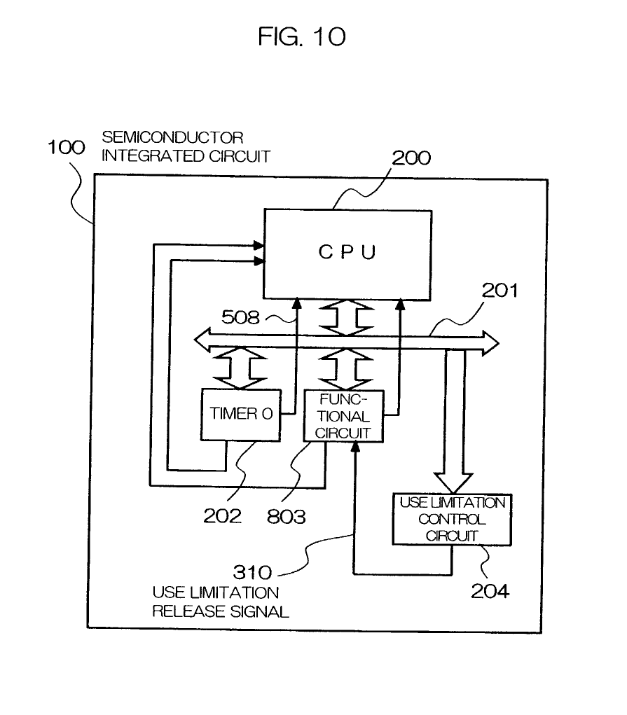

A sixth embodiment relates to an authentication circuit 301. FIG. 9(a) is a conceptual view of a configuration of the authentication circuit 301; FIG. 9(b) is a concrete configuration view of the authentication circuit 301; and FIG. 9(c) is a truth table for the authentication circuit 301. The authentication circuit 301 comprises a logic circuit 350 in which three-bit-length input data a, b, c are input; logical operation is performed; and an output datum out is output. The output datum out becomes a release signal 310. The logic circuit 350 is configured as a combinational circuit, comprising: for example, an inverting circuit 351 which inverts and inputs the input datum b; and an AND circuit 352 of three inputs.

Only when the input datum a is “1”, the input datum b is “0”, and the input datum c is “1”, the output datum out becomes “1”. The output datum is left as “0” for combination of the input data except the above one. A specific combination of the input data a, b, c becomes a key datum for use permission.

Here, the authentication circuit may comprise a sequential circuit. In this case, a plurality of key datum registers may be used as corresponding one to a key datum register 300, or means by which a plurality of values are sequentially written into one key datum register is required.

(Seventh Embodiment)

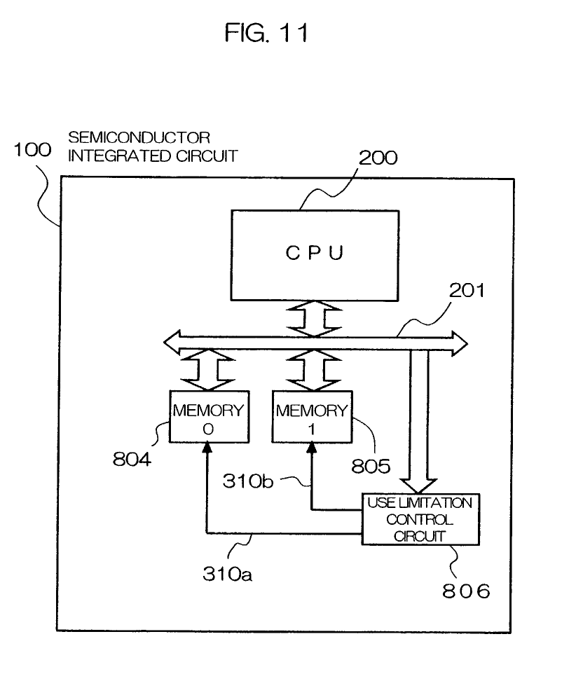

FIG. 10 is a block diagram showing a configuration of an integrated circuit according to the seventh embodiment of the present invention. Different from the embodiments described above, an integrated circuit 100 installs another functional circuit 803 as a limited module, instead of a timer.

The functional circuit 803 may be, for example, a circuit for debugging. In this case, the integrated circuit with a debugging function is obtained by configuration in which the circuit for debugging is effectively switched according to a release signal 310 from a control circuit 204. In a similar manner to that of the first embodiment, a key datum for use permission is input to the control circuit 204, from which the release signal 310 is output after authentication.

Unless the circuit for debugging is made efficient by the key datum, the integrated circuit with no debugging function is obtained. The integrated circuit 100 may be provided at a low price to a user who does not use the debugging function, and consideration may be obtained as an added value from a user who uses the debugging function.

There is no need to design, develop, produce another chip for debugging, and advantages of mass production may be obtained by producing the same integrated circuit.

(Eighth Embodiment)

A limited module may be assumed to be treated as an optional memory.

FIG. 11 is a block diagram showing a configuration of an integrated circuit according to the eighth embodiment. Different from the embodiments described above, an integrated circuit 100 installs a plurality of optional memories 804, 805 as limited modules.

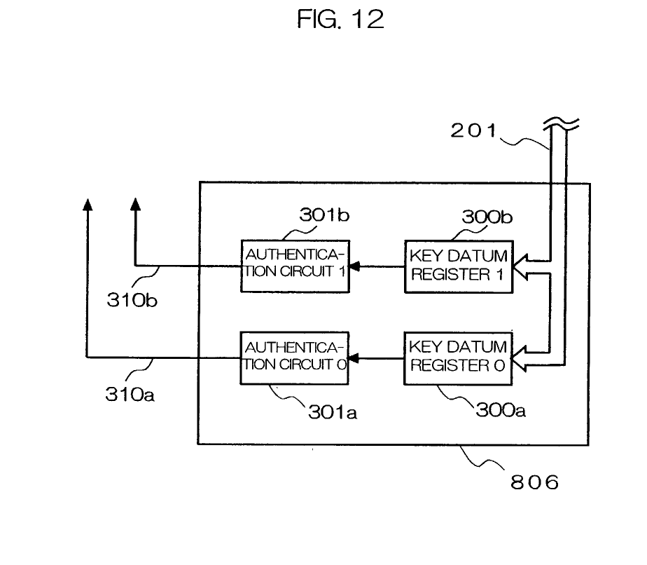

As shown in FIG. 12, a control circuit 704 in this embodiment comprises: a first and a second key datum registers 300a, 300b which are connected to a memory bus 201, and a first and second authentication circuits 301a, 301b which are corresponding to the registers mentioned above, respectively. The first authentication circuit 301a and the second authentication circuit 301b are different from each other in permission information as a comparison standard datum. Permission information to release the use limitation of the first memory 804 has been held in advance in the first authentication circuit 301a. Permission information to release the use limitation of the second memory 805 has been held in advance in the second authentication circuit 301b. In order separately to make the first memory 804 and the second memory 805 invalid/valid, the first release signal 310a is supplied from the first authentication circuit 301a to the first memory 804. And, the second release signal 310b is supplied from the second authentication circuit 301b to the second memory 805.

The memory capacity may be made variable by selecting a number of memories which may be used as an option. Advantages of mass production may be obtained by producing the same integrated circuit for a plurality of memory capacities. Moreover, right consideration can be obtained according to each memory capacity.

Here, the number of memories is arbitrary, and may be one or more than three, though two memories have been installed as optional memories in the above description. In addition, a cache memory may be substituted for the optional memory.

(Ninth Embodiment)

A system clock generation circuit may be used as a limited module.

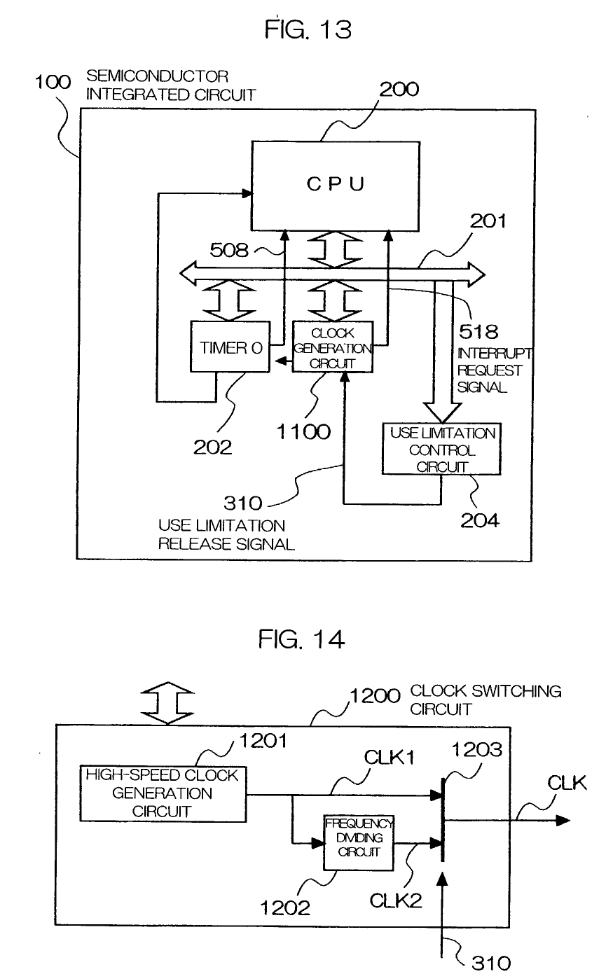

FIG. 13 is a block diagram showing a configuration of an integrated circuit according to the ninth embodiment. Different from the embodiments described above, an integrated circuit 100 installs an optional clock generation circuit 1100 as a limited module. As other parts of the configuration are similar to those of FIG. 1, similar parts are denoted by the same reference numerals as those in FIG. 1, and description will be eliminated. Moreover, the configuration of FIG. 2 is applied to the present embodiment.

When a release signal 310 from a control circuit 204 is made valid, the clock generation circuit 1100 may be used. A clock which the clock generation circuit 1100 generates may be a more high-speed clock than a standard clock. Or, conversely, the generated clock may be a more low-speed clock than a standard clock.

The integrated circuit may be provided at a low price to a user who does not use the optional clock generation circuit 1100. Consideration as an additional value may be obtained from a user using the circuit 1100. Advantages of mass production may be obtained at producing by making the specifications of integrated circuits, which may meet a plurality of user requirements, the same.

(Tenth Embodiment0)

The tenth embodiment relates to a modification of the ninth embodiment, and a clock switching circuit is used instead of a limited module.

FIG. 14 is a block diagram showing a configuration of a clock switching circuit 1200. The clock switching circuit 1200 comprising: a high-speed clock generation circuit 1201; a frequency dividing circuit 1202; and a selector 1203. The output of the high-speed clock generation circuit 1201 is connected to the input of the frequency dividing circuit 1202. The frequency dividing circuit 1202 generates a low-speed clock CLK2 by frequency division of a high-speed clock CLK1 from the high-speed clock generation circuit 1201. The selector 1203 selects the high-speed clock CLK1 or the low-speed clock CLK2 according to a release signal 310, and outputs the selected one as an internal clock CLK actually to be used. The frequency dividing rate of the frequency dividing circuit 1202 is arbitrary.

When the release signal 310 from the control circuit 204 is “0”, the selector 1203 selects the low-speed clock CLK2 from the frequency dividing circuit 1202 as an internal clock CLK. A key datum for use permission has been established in the control circuit 204. When the release signal 310 is switched to “1”, the selector 1203 selects as an internal clock CLK the high-speed clock CLK1 from the high-speed clock generation circuit 1201.

(Eleventh Embodiment)

The eleventh embodiment has a configuration in which two limited modules are circuits which have a similar function to each other and the versions are different from each other.

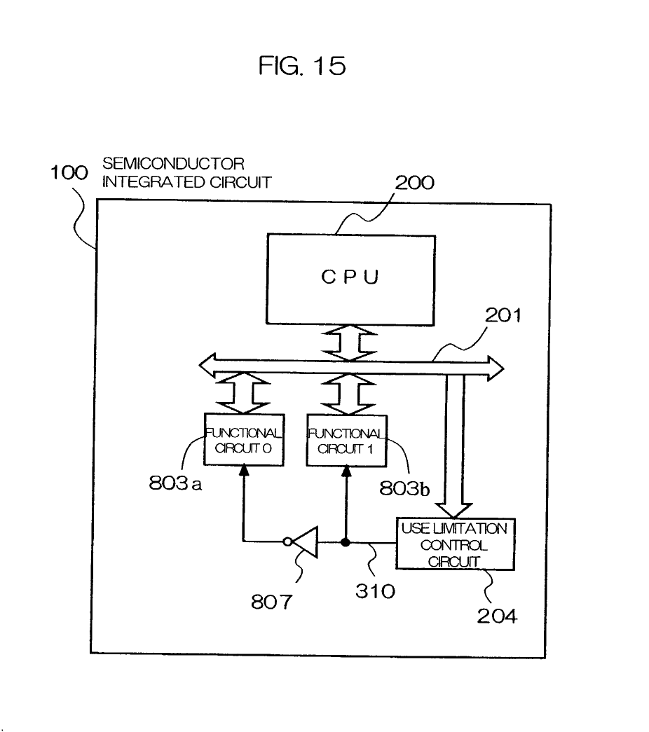

FIG. 15 shows a schematic configuration of an integrated circuit according to the eleventh embodiment. A release signal 310 from a control circuit 204 is supplied to a first functional circuit 803a through an inverting circuit 807. The release signal 310 is directly supplied to a second functional circuit 803b. Thereby, the first functional circuit 803a is made valid, and the second functional circuit 803b is made invalid, when the release signal 310 is “0” as usual. Conversely, the first functional circuit 803a is made invalid, and, instead, the second functional circuit 803b is made valid, when the release signal 310 is switched to “1”. That is, a relation between the invalid state/valid state of both the functional circuits is an exclusive one. It is assumed that permission information as a comparison standard for an authentication circuit 301 in the control circuit 204 is in common for the first functional circuit 803a and the second functional circuit 803b.

If the version of the second functional circuit 803b is of a higher level than that of the first functional circuit 803a, a key datum for use permission may be provided to a user paying consideration, and it may be permitted to use the second functional circuit 803b.

Here, in a case as one form of modifications in which a plurality of functional circuits are limited ones, and are exclusively used each other, the configuration is as follows. That is, there may be considered a configuration in which control is performed using two key data, that is, a key datum for making a function valid, and a key datum for selecting a version exclusively.

(Twelfth Embodiment)

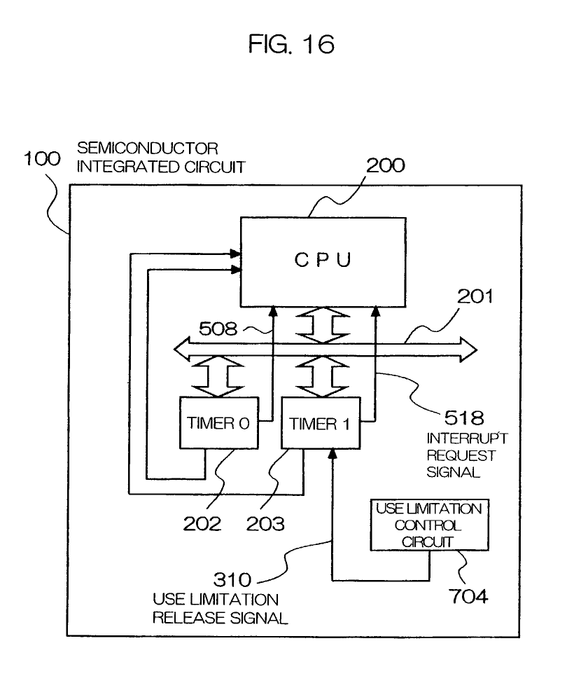

FIG. 16 is a block diagram showing a configuration of an integrated circuit according to the twelfth embodiment. In an integrated circuit 100, a use limitation control circuit 704 has a different configuration from those of the embodiments described above. Control circuits 204 in the embodiments hitherto have been provided with a key datum register 300 connected to a memory bus 201, and an authentication circuit 301, as shown in FIG. 2. In the present embodiment, a control circuit 704 which is not connected to the memory bus 201 is provided, instead of the key datum register and the authentication circuit. As a concrete configuration of the control circuit 704, a pad only for a key is provided. A potential terminal of the pad only for a key is bonded to any one of a power supply VDD at a high potential side, and a power supply GND at a low potential side by wire bonding. A conductive wire outgoing from the pad only for a key is used as a release signal 310. Then, it is configured to decide the presence of a key datum for use permission, using the release signal. As other parts of the configuration are similar to those of FIG. 1, similar parts are denoted by the same reference numerals as those in FIG. 1, and description will be eliminated. Moreover, the configurations of FIG. 3, and FIG. 4 is applied to the present embodiment.

As a modification form of the control circuit 704, the presence of the key datum may be decided by fixing the potential of the pad only for a key at any one of a potential of the power supply VDD at the high potential side, and a potential of the power supply GND at the low potential side through laser cutting or ion driving.

(Thirteenth Embodiment)

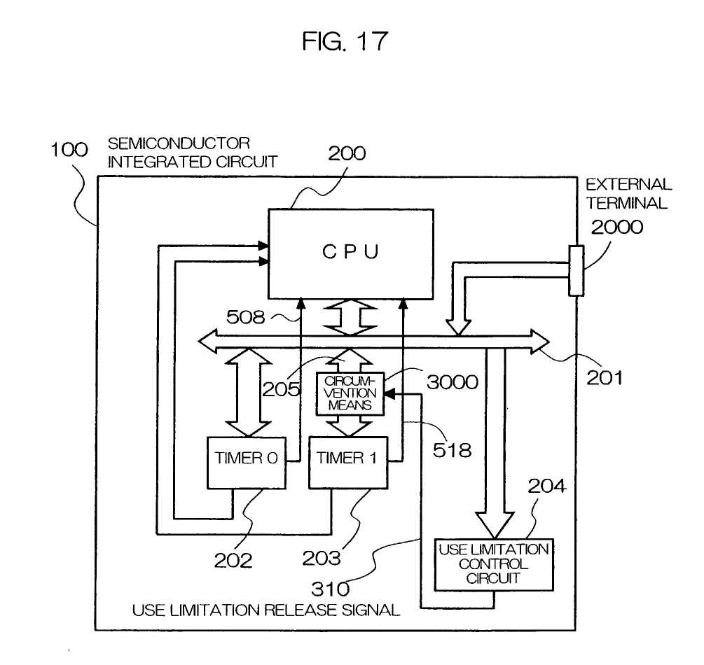

FIG. 17 is a block diagram showing a configuration of an integrated circuit according to the thirteenth embodiment. The configurations of FIG. 2, FIG. 3, and FIG. 4 are applied to the present embodiment. An integrated circuit 100 is provided with circumvention means 3000. The circumvention means 3000 is inserted into a bus 205 through which a timer 203 is connected to a memory bus 201. The circumvention means 3000 is configured to be controlled by a release signal 310 from a control circuit 204. When the release signal 310 is inactive “0”, the circumvention means 3000 makes the control means in the bus 205, or exchanging of datum invalid, and the timer 203 is held in a use limitation state. When the release signal 310 is switched to “1”, the circumvention means 3000 is reset; the control means in the bus 205, and exchanging of data are made valid; and the use limitation of the timer 203 is released. In this case, the circumvention means 3000 corresponds to “use limitation/release means” defined in the claims.

Here, the circumvention means 3000 may make a control signal input to the timer 203 invalid, or input datum invalid. Data output from the timer 203 may be made invalid, or a control signal such as an interrupt request signal 518 to be output may be made invalid.

Here, though an external terminal 2000 is shown in the drawing, this is one example, and other forms which have already been described may applied.

(Fourteenth Embodiment)

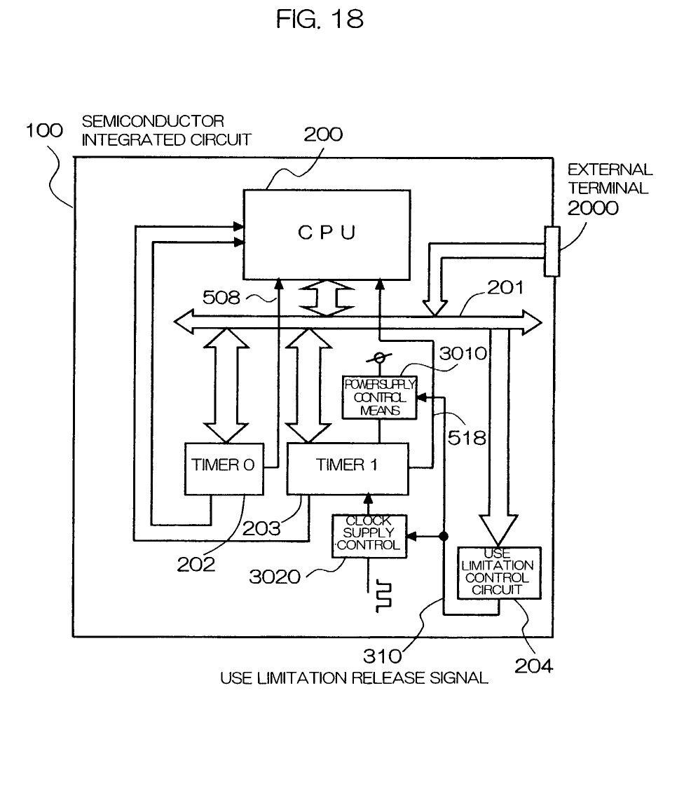

FIG. 18 is a block diagram showing a configuration of an integrated circuit according to the fourteenth embodiment. The configurations of FIG. 2, FIG. 3, and FIG. 4 are applied to the present embodiment. An integrated circuit 100 is provided with power supply control means 3010 controlling power supply to a timer 203, and clock supply control means 3020 controlling supply of clocks to the timer 203.

The power supply control means 3010 is configured to be controlled by a release signal 310 from a control circuit 204. When the release signal 310 is inactive “0”, the power supply control means 3010 stops power supply to the timer 203, and the power consumption may be reduced. When release signal 310 is switched to “1”, the power supply control means 3010 starts power supply to the timer 203, and releases the use limitation.

Also, the clock supply control means 3020 is configured to be controlled by the release signal 310 from the control circuit 204. When the release signal 310 is inactive “0”, the clock supply control means 3020 stops clock supply to the timer 203. Thereby, use limitation of the timer 203 is substantially performed. When release signal 310 is switched to “1”, the clock supply control means 3020 starts clock supply to the timer 203, and releases the use limitation of the timer 203.

In this case, the power supply control means 3010 and the clock supply control means 3020 correspond to “use limitation/release means” defined in the claims.

In principle, any one of the power supply control means 3010 and the clock supply control means 3020 may be provided, but both of them may be included.

The clock supply control means 3020 may perform substantial use limitation by reducing clock frequencies and degrading the performance of the timer 203, as well as by cutting clock supply to the timer 203.

Here, though an external terminal 2000 is shown in the drawing, this is one example, and other forms which have already been described may be applied.

(Fifteenth Embodiment)

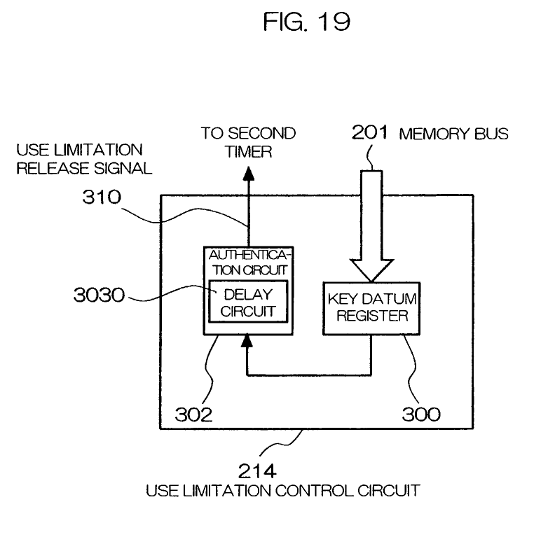

FIG. 19 is a block diagram showing a configuration of an use limitation control circuit according to the fifteenth embodiment.

A use limitation control circuit 214 comprises: a key datum register 300; and an authentication circuit 302 with a delay circuit 3030. The authentication circuit 302 is configured to start authentication operation at receiving a key datum for use permission from the key datum register 300 after required idling time (delay time), which the delay circuit 3030 has, has passed.

Illegal release is prevented even if the third party, to whom a normal key datum for use permission is not given, tries illegally to release use limitation, as it takes time too much because of idling of the delay circuit 3030 mentioned above.

That is, a key datum releasing use limitation is going to be found by sending a key datum for trial to the key datum register 300. However, the authentication circuit 302 actually starts authentication operation after idling time in the delay circuit 3030 has passed. Then, authentication roughly causes negative results, and the third party retries another key datum for trial. Though the trial is repeated many times, the use limitation may not be easily overcome as there is idling in the delay circuit 3030 at each trial. That is, illegal acquisition of the key datum is made difficult by lowering efficiency of one by one retrieval.

When a normal user establishes a correct key datum, there is idling only one time in the delay circuit 3030. In this case, the authentication circuit 302 authenticates that the key datum is a normal key datum, and the release signal 310 is made active. The operation delay at this time is a little.

As a developed form of the present embodiment, a configuration, in which the delay circuit 3030 is made inactive only when the normal key datum is input, and the delay circuit 3030 is made active when a not-normal key datum is input, is further preferable. In the case of the normal key datum, the active release signal 310 may be output at once without idling.

(Sixteenth Embodiment)

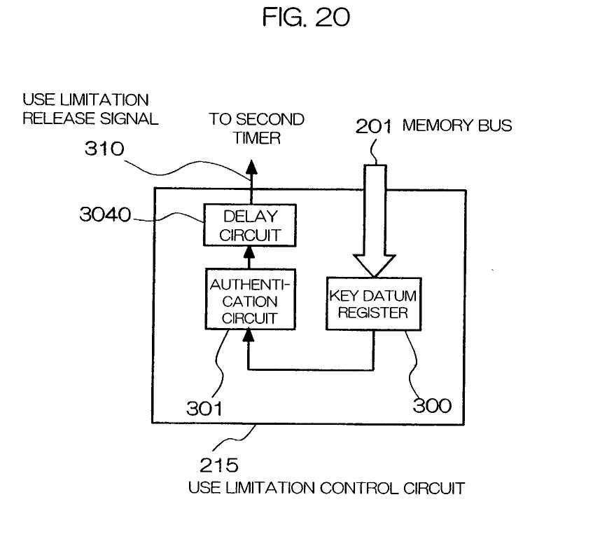

FIG. 20 is a block diagram showing a configuration of a use limitation control circuit according to the sixteenth embodiment of the present invention.

A use limitation control circuit 215 is provided with a key datum register 300, an authentication circuit 301, and a delay circuit 3040 at the output side of the authentication circuit 301. The authentication circuit 301 starts authentication operation at once, when the key datum for use permission is received from the key datum register 300, and outputs an authentication result signal. A delay circuit 3040 delays an effective output. A substantial release signal 310 is output after required idling time (delay time), which the delay circuit 3040 has, has passed.

A preventive function for illegal release of use limitation by the third party is realized in a similar manner to the embodiments described above. That is, illegal acquisition of the key datum is made difficult by lowering efficiency of one by one retrieval.

(Seventeenth Embodiment)

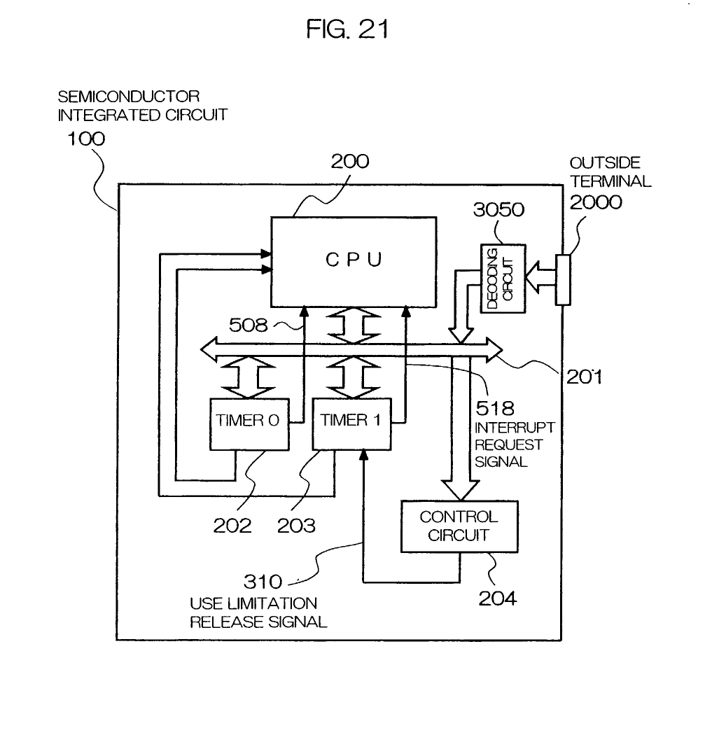

FIG. 21 is a block diagram showing a configuration of an integrated circuit according to the seventeenth embodiment.

The configurations of FIG. 2, FIG. 3, and FIG. 4 are applied to the present embodiment. An integrated circuit 100 is provided with a decoding circuit 3050 decoding (cipher releasing) an enciphered key datum for use permission which is input from an external terminal 2000. The decoding circuit 3050 is connected to a memory bus 201, and supplies the decoded key datum to a control circuit 204. It becomes difficult to acquire the key datum illegally by enciphering the key datum. In this case, the external terminal 2000, and the decoding circuit 3050 correspond to “key information acquisition means” defined in the claims.

Here, decoding of the key datum may be configured to be performed in a CPU 200.

(Eighteenth Embodiment)

In the eighteenth embodiment according to the present invention, it is configured to decide the presence of a key datum for use permission by bonding a potential terminal of the pad only for a key to any one of a power supply VDD at a high potential side, and a power supply GND at a low potential side through a cutting method of a semiconductor wafer.

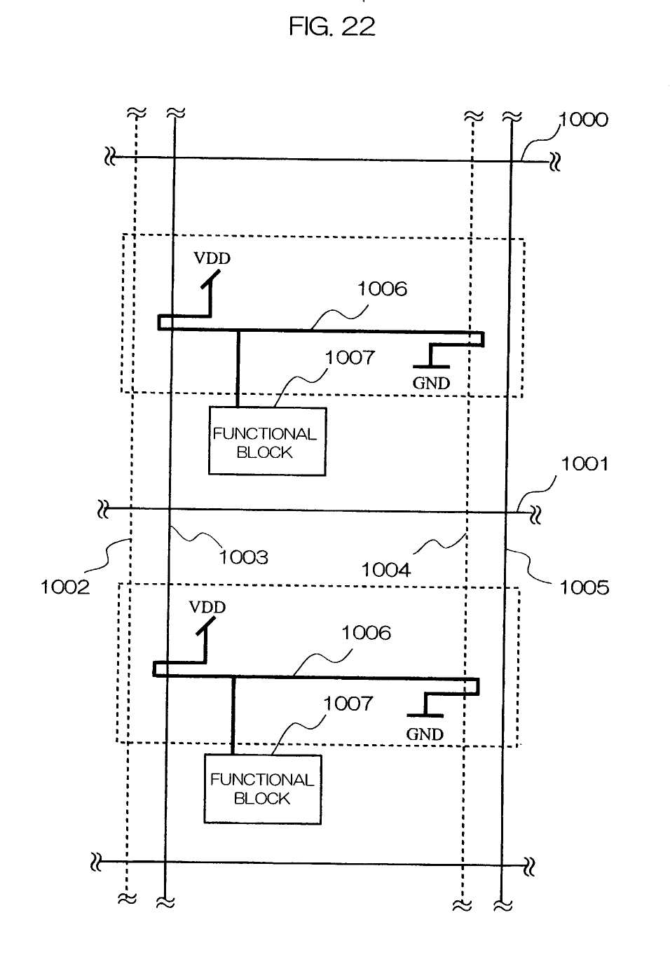

FIG. 22 shows a cutting example of a semiconductor wafer. 1000 through 1005 are cutting lines; 1006 is a power supply line; and 1007 is a functional block. The cut line 1002, and the cut line 1004; and the cut line 1003, and the cut line 1005 make a pair. With regard to these two pairs, only any one of them is selected in one semiconductor wafer.

In this case, the power supply line 1006 is disconnected from the power supply GND at a low potential side, and connected to the power supply VDD at the high potential side by cutting according to the cut lines 1002,1004, when a functional block 1007 is made valid. When the functional block 1007 is made invalid, cutting is performed according to the cut lines 1003,1005. As a result, the power supply line 1006 is disconnected from the power supply VDD at the high potential side, and connected to the power supply GND at the low potential side.

Here, it is considered with regard to a dicing device of a semiconductor wafer that the release signal 310 mentioned above may be used for selection of the cut lines 1002, 1004, and ones 1003, 1005.

(Other Embodiments)

The embodiments described above have shown that writing “1” into a count enabling part 510b is masked as use limitation/release means in a timer 203. However, any of control signals or data may be masked, when a function as a timer is made invalid.

Moreover, though it has been described as an example in the embodiments described above that a provider of the key datum is the same with a provider of an integrated circuit, it is not necessarily required that both the providers are the same. When the providers are not the same, the provider of the key datum is meant to purchase a providing right of the key datum.

Here, the present integrated circuit is effective for a case in which many functions are accumulated like in a system LSI. The system LSI is also used for different systems having similar functions, and there are many cases in which a part of functions are used for the different systems. The integrated circuit is also advantageous in this respect.

In addition, the integrated circuit may include a plurality of LSIs, though cases in which the integrated circuit comprises one LSI have been shown in the above description. For example, when a memory part is manufactured in a different process, the present invention may be applied, for example, for a multi chip module into which a memory part and the other parts are manufactured in separate chips and the chips are constructed in a package as one integrated circuit.

Here, a CPU 200 is installed in an integrated circuit 100 in the embodiments described above, but the CPU is not necessarily installed. The integrated circuit may be configured to be controlled by a CPU outside the integrated circuit 100.

That is the description of configurations of the integrated circuit. Then, embodiments of a business system related with the integrated circuit mentioned above will be described.

(Nineteenth Embodiment)

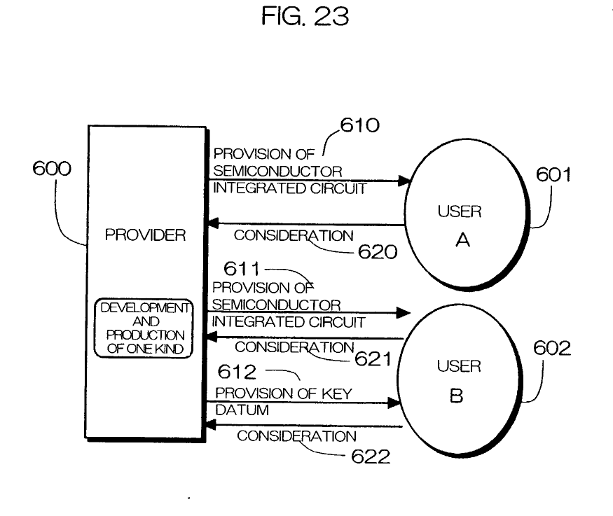

FIG. 23 is a view of a system configuration for a business system according to a nineteenth embodiment of the present invention. 600 is a provider who develops, produces, and sells an integrated circuit 100, 601, 602 are a first user and a second users who buy and use the integrated circuit 100, respectively. 610 shows that the provider 600 provides the integrated circuit 100 to the first user 601, and 611 shows that the provider 600 provides the integrated circuit 100 to the second user 602. 612 shows that the provider 600 provides a key datum for use permission to the second user 602.

620 shows that the first user 601 pays to the provider 600 consideration for the integrated circuit 100 which is provided to the first user, and 621 shows that the second user 602 pays to the provider 600 consideration for the integrated circuit 100 which is provided to the second user.

622 shows that the second user 602 pays to the provider 600 consideration for the key datum which is provided to the second user.

The second user 602 performs processing for storing the key datum, which is provided in the processing 612, into a key datum register 300 of the integrated circuit 100. Thereby, authentication in an authentication circuit 301 is performed. The processing corresponds to an authentication step.

When it is authenticated that the key datum stored in the key datum register 300 is correct, a release signal 310 from the authentication circuit 301 becomes “1” representing a valid state, and use limitation of a second limited module is released. This corresponds to a step of releasing the use limitation.

As described above, the first user 601 who has not received the key datum uses the integrated circuit 100 under a state in which the second limited module may not be used. As the second limited module is not used, it is required to pay only consideration 620.

The second user 602 uses the integrated circuit 100 for which the second limited module can be used. The integrated circuit 100 mentioned above has a higher added value than that of the integrated circuit 100 which the first user 601 uses. Therefore, both of the consideration 621 for the integrated circuit 100, and the consideration 622 for the key datum are required to be paid.

The provider 600 has an advantage that pricing of the added value may be reasonably performed.

Moreover, there is no need at development/production of the integrated circuit 100 to develop/produce for the first user 601 the integrated circuit which eliminates the second limited module.

Conversely, there is no need to develop/produce for the second user 602 the integrated circuit which has installed the second limited module, when the integrated circuit which has not originally installed the second limited module has been provided to the first user 601.

Thereby, advantageously, the development cost may be reduced as only one kind of the integrated circuit may be developed; the advantages by mass production may be easily realized at production as the number of the kinds is one; and there is higher opportunity of obtaining more effects in cost reduction.

Modifications of the present embodiment will be described as follows. That is, there are a plurality of limited modules which are installed in the integrated circuit, when the key datum is provided in the processing 612. There are a case in which the key datum corresponding to one of the modules mentioned above is provided, and a case in which a plurality of key data are provided. In both cases, use limitation of the corresponding limited modules is released according to the provided key datum. Payment of the consideration 622 can be determined according to the value of the functions of modules of which use limitation has been released.

(Twentieth Embodiment)

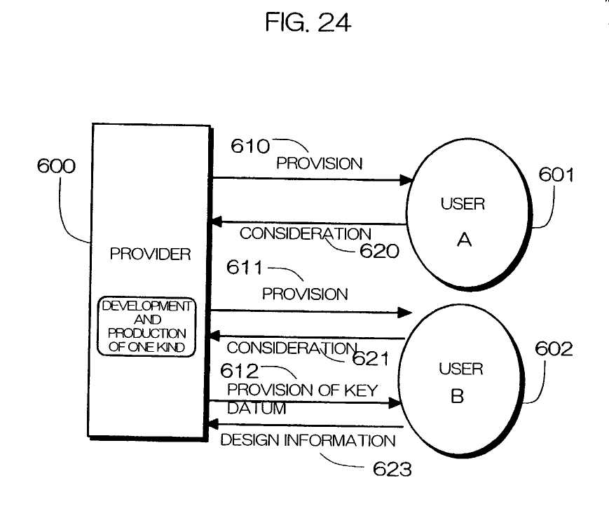

FIG. 24 is a view of a system configuration for a business system according to a twentieth embodiment of the present invention. Different from the configuration shown in FIG. 23, a user gives design information 623 on the second limited module, instead of the consideration 622, to the provider of the integrated circuit.

The provider 600 receives the design information 623 provided from the second user 602, and designs and mounts the second limited module based on the received design information.

The second user 602 may use the second limited module as the key datum is provided through the processing 612. However, the first user 601 may not use the second limited module, as the key datum is not provided to the first user 601. The additional value of the integrated circuit 100 is increased by release of use limitation of the second limited module. Therefore, the second user 602 may differentiate a system, which the second user creates, from that of the first user 601.

Even in this case, there is no need at development/production of the integrated circuit 100 to develop/produce for the first user 601 the integrated circuit which eliminates the second limited module.

Thereby, the development cost may be reduced as only one kind of the integrated circuit may be developed. Moreover, advantageously, the advantages by mass production may be easily realized at production as the number of the kinds is one; and there is higher opportunity of obtaining more effects in cost reduction.

(Twenty-First Embodiment)

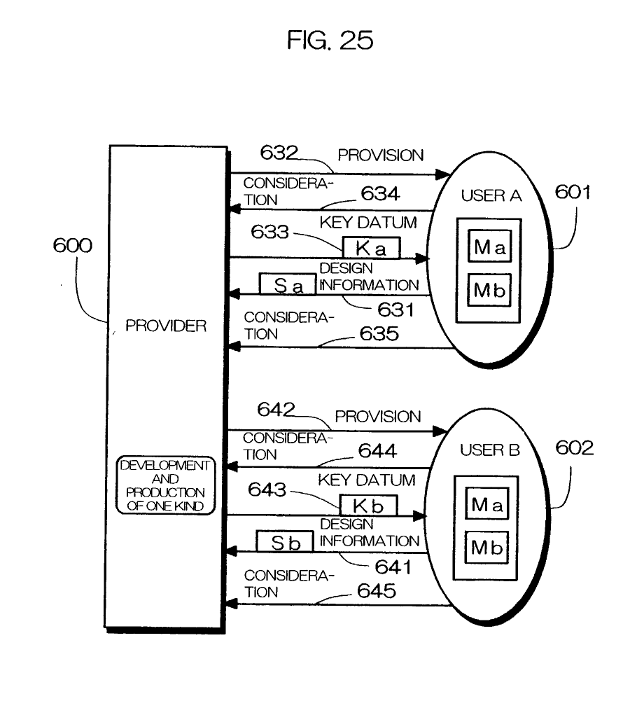

FIG. 25 is a view of a system configuration for a business system according to a twenty-first embodiment of the present invention.

A first user 601 gives design information Sa on the first limited module Ma to the provider 600 (631). And, a second user 602 gives design information Sb on the second limited module Mb to the provider 600 (641). These two modules are different from each other.

The provider 600 produces an integrated circuit mounting both the limited modules Ma, Mb, based on the provided design information Sa and Sb.

The provider 600 provides to the first user 601 the integrated circuit mounting two limited modules Ma, Mb (632). Similarly, an integrated circuit with the same specifications is provided to the second user 602 (642).

Moreover, the provider 600 provides to the first user 601 a first key datum Ka for releasing use limitation of the first limited module Ma (633). Similarly, a second key datum Kb for releasing use limitation of the second limited module Mb is provided to the second user 602 (643).

The first user 601 releases use limitation of the first limited module Ma, using the provided first key datum Ka. Then, the first user 601 pays consideration for the integrated circuit (634), and, at the same time, for the first key datum Ka to the user 600 (635).

And, the second user 602 releases use limitation of the second limited module Mb, using the provided second key datum Kb. Then, the second user 602 pays consideration for the integrated circuit (644), and, at the same time, and for the second key datum Kb to the user 600 (645).

In this case, as the first user 601 has not receive the second key datum Kb, the first user 601 may not use the second limited module Mb. And, as the second user 602 has not receive the first key datum Ka, the second user 602 may not use the first limited module Ma. That is, the relation mentioned above is an exclusive relation.

Modules, which are not required and not used for the first user 601, and for the second user 602, are installed. However, the cost may be reduced by advantages, which has been caused by common specifications, of mass production. And there may be flexible correspondence to later function enhancement.

(Twenty-Second Embodiment)

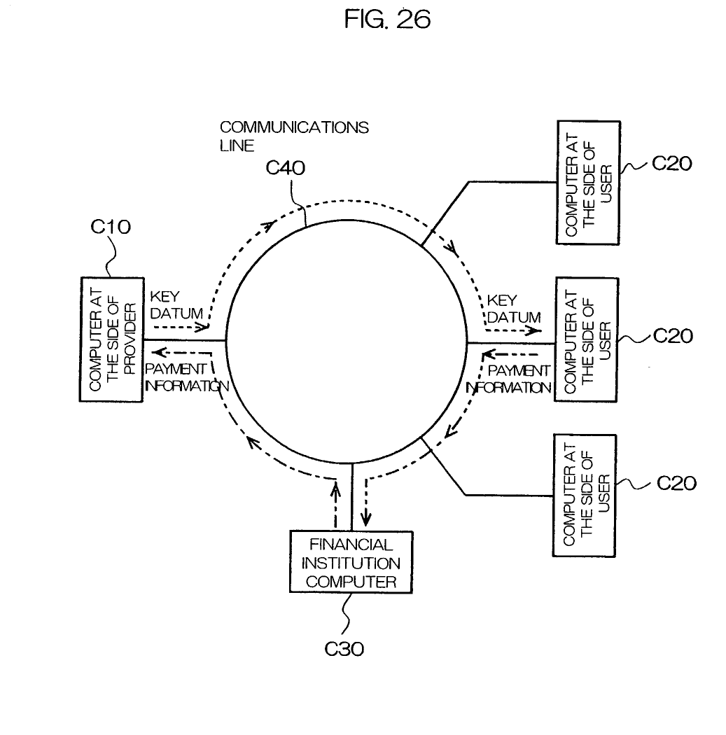

The twenty-second embodiment relates to a business method in electronic commerce performed between a computer at the side of a provider of an semiconductor integrated circuit, and computers at the side of users through a communications line. FIG. 26 is a view of a system configuration for a business system according to a twenty-second embodiment of the present invention.

A computer C10 at the side of the provider, computers C20 at the side of the users, and a financial institution computer C30 are connected to each other through a communications line C40. The communication between the three computers may be directly performed through the communications line C40, or through a server computer (not shown) of the provider. A computer at the side of a manufacturer, or a computer at the side of a seller of the integrated circuit is used as the computer of the provider C10. With regard to the computers at the side of the users C20, a plurality of computers corresponding to each of a plurality of users are individually connected to the communications line C40. The financial institution computer C30 is a computer of the financial institution with which both the side of the provider and the side of the users commonly make contract, and can make settlements of accounts by transmitting/receiving electronic money. For the object mentioned above, appropriate security functions are obviously provided. Here, the number of the financial institution computer C30 is not limited to only one, in some cases, a network comprising a plurality of computers connected through an individual, dedicated communications line in the financial institution may be included. The number of financial institutions in this case is not limited to one corporation, but also a plurality of corporations may be included in some cases.

The integrated circuit installing one or a plurality of limited modules is provided from the side of the provider to the side of the users through some channels of distribution.

The user side makes a request for a key datum to the side of the provider while limited modules are specified. The request is made not only by access to the computer at the side of the provider C10 from the computers at the side of the users C20 through the communications line C40, and but also by any other method through telephones, facsimiles, mails, oral communication, and the like. With regard to specification of the number of modules, one module or a plurality of modules may be accepted.

When the request mentioned above is received, the computer at the side of the provider C10 transmits the key datum related with the request mentioned above to the computers at the side of the users C20 through the communications line C40.

With regard to the transmission of the key datum, the following modes are acceptable and any one of them may be acceptable.

One mode is a mode in which all the processing steps, such as acceptance of the request mentioned above, recording, deciding, extracting of the pertinent key datum, and transmitting and recording of extracted key datum, are automatically performed as internal processing of the computer at the side of the provider C10. In another mode, any of the plurality of processing steps mentioned above are performed by artificial operations of a computer operator. In the both modes, an data base attached to the computer is used.

The side of the users, who have received the key datum at the computers of the side of the user C20 through the communications line C40, releases use limitation of the limited module, using the key datum. At this releasing. the form in which the key datum is used is arbitrary. The releasing processing may be performed by direct connection of the computers at the side of the users C20 to the semiconductor integrated circuit, or by giving the key datum fetched from the computers at the side of the users C20 to a dedicated computer or device. Fetching of the key datum in this case may be performed by transfer through a local area network, or through a removable recording medium such as FD (floppy disk), CD-R (compact disk recordable).

The computers at the side of the users C20 transmit to the communications line C40 payment information causing settlement of electronic money corresponding to consideration for use of the key datum. In this case, the payment information on consideration for use of the key datum, and at the same time on consideration for the semiconductor integrated circuit itself may be also transmitted. In the present embodiment, the payment information is received in the financial institution computer C30. Here, the computer at the side of the provider C10 may directly receive the information as another form.

The financial institution computer C30 which has received the payment information performs settlement processing of the electronic money between the account of the side of the users and that of the provider. At completion of the settlement processing mentioned above, the financial institution computer C30 transmits payment information including one that the settlement processing has been completed to the computers at side of the users C20, and the computer at the side of the provider C10 through the communications line C40. The computer at the side of the provider C10 records the received payment information in a recording medium such as a hard disk. The computers at the side of the users C20 also record the received payment information.

In the description mentioned above, the electronic settlement may be performed not through the financial institution computer C30. In this case, the electronic money is directly transmitted from the computers at the side of the users C20 to the computer at the side of the provider C10 and at the same time the payment information is transmitted.

Here, the transmission of the key datum may be performed in the above description on condition that payment of the consideration for the integrated circuit should be completed.

(Twenty-Third Embodiment)

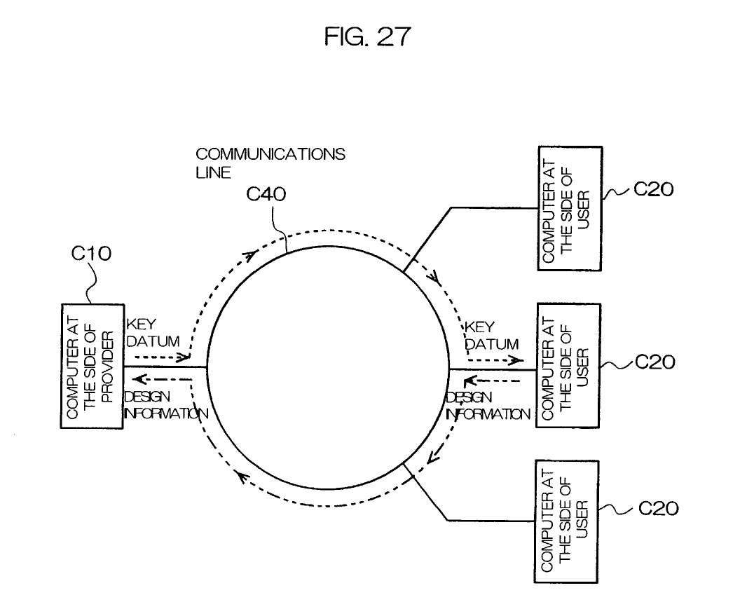

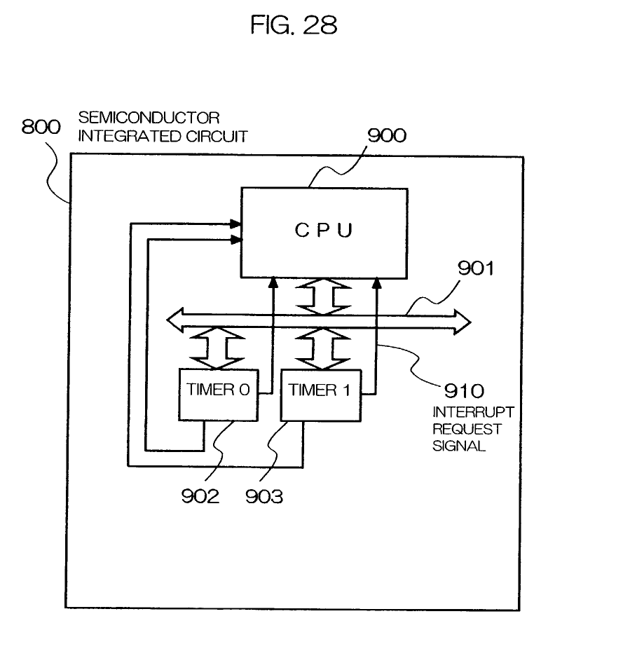

The twenty-third embodiment relates to a business method in electronic commerce in which design information is provided from the side of the users to that of the provider. FIG. 27 is a view of a system configuration for a business system according to a twenty-third embodiment of the present invention.

Design information on a functional module is transmitted from computers at the side of users C20 to a computer at the side of a provider C10 through a communications line C40. The design information is developed by the users, and the side of the provider is asked for production of an integrated circuit installing a functional module based on the design information. The design information is received in the computer at side of the provider C10, and the design information is recorded in a recording medium such as a hard disk.

The side of the provider produces the integrated circuit installing the functional module which has been developed based on the received design information mentioned above. At this time, the functional module is produced as a limited module. The produced integrated circuit is provided from the side of the provider to those of the users through some channels of distribution. And, the key datum for releasing use limitation of a limited module corresponding to the design information mentioned above is transmitted at appropriate time from the computer at the side of the provider C10 to the computers at the side of the users C20 through the communications line C40. In the computers at the side of the users C20, the use limitation of the limited module is released, using the key datum, after recording the received key datum.

In the present embodiment, the electronic settlement is not performed in principle. However, the electronic settlement may be performed through the communications line C40 in a similar manner to that of the twenty-second embodiment, when a part of the consideration is paid by the side of the users based on an agreement between the side of the provider and that of the users.

As described in detail, the following advantages are obtained according to the semiconductor integrated circuit according to the present invention. That is, the use limitation of the limited module is released by provision of the key information according to requests, and appropriate consideration for the releasing may be obtained, when one kind of the integrated circuit with common specifications is provided to a plurality of users having different requests respectively. That is, the consideration for functions required by the users may be obtained, and use of functions not required by the users may be limited.

Moreover, there may be further development in which the key information is provided, and use limitation of the limited module is released when the users require function enhancement. As shown above, the function enhancement becomes possible without change of the integrated circuit, and consideration for the function enhancement may be obtained as consideration for the key information.

Moreover, advantages by mass production may be obtained as the integrated circuit is developed, and produced in a small number of kinds. Though functions not required by some users are installed, increased price may be eased, considering the advantages mentioned above of mass production.

And, key information releasing use limitation of a limited module is provided to the users providing design information on the pertinent module, and it is possible to conceal the limited module from other users by no provision of the pertinent key information to other users.

In addition, there is an advantage in prevention of illegal acquisition of the key information.

And, there are the following advantages by the business method according to the present invention. That is, price setting may be performed for each module in the integrated circuit, and it may be controlled through the key information to decide whether a limited module is used or not. A reasonable balance between meeting required specifications of a plurality of users, and consideration to be paid may be realized. Moreover, a required module may be used at anytime by acquisition of the key information at function enhancement even when the module is not used first.

While there has been described what is at present considered to be preferred embodiments of this invention, it will be understood that various modifications may be made therein, and it is intended to cover in the appended claims all such modifications as fall within the true spirit and scope of this invention.

What is claimed is:

1. A semiconductor integrated circuit, comprising:
at least one functional module with use limitation use of which is limited in a state in which use limitation release information is invalid;
key information acquisition means for acquiring key information for use permission in order to make the functional module with use limitation valid; and
use limitation control means for use permission by authenticating the key information for use permission given from the key information acquisition means based on the use permission information which has been held in advance, by making the use limitation release information valid only when authenticated, and by giving said valid use limitation release information to the functional module with use limitation.

2. A semiconductor integrated circuit according to claim 1, wherein
the use limitation control means comprising:
a key information holding means for holding the key information for use permission; and
authentication means by authenticating the key information for use permission, which has been held in the key information holding means, based on use permission information which has been established in advance, and by making the use limitation release information valid only when authenticated.

3. A semiconductor integrated circuit according to claim 1, wherein
the key information acquisition means is processing by which
a central processing unit generates the key information for use permission according to a program, and
the generated key information for use permission is given to the use limitation control means.

4. A semiconductor integrated circuit according to claim 1, wherein
the key information acquisition means includes an external terminal by which the key information for use permission can be established from the outside.

5. A semiconductor integrated circuit according to claim 1, wherein
the key information acquisition means includes a nonvolatile memory holding the key information for use permission.

6. A semiconductor integrated circuit according to claim 5, wherein
the nonvolatile memory attaches an information input terminal into which the key information for use permission is written from the outside; and
the written key information for use permission is read out by a central processing unit, and given to the use limitation control means.

7. A semiconductor integrated circuit according to claim 5, wherein
the key information for use permission, which a central processing unit has generated according to a program, is written into the nonvolatile memory; and
the written key information for use permission is read out by the central processing unit, and given to said use limitation control means.

8. A semiconductor integrated circuit according to claim 1, wherein
the key information acquisition means includes a register storing the key information for use permission which a central processing unit has generated according to a program;
the central processing unit reads out the key information for use permission from the register according to a program; and
the key information for use permission, which has been read out, is given to the use limitation control means.

9. A semiconductor integrated circuit according to claim 1, wherein
the key information acquisition means includes:
information receiving means for receiving the key information for use permission, which is given from the outside through electromagnetic waves;
a demodulation means for demodulating the key information for use permission which the information receiving means has received; and
a register holding the key information for use permission which the demodulation means has demodulated.

10. A semiconductor integrated circuit according to claim 1, wherein
the key information acquisition means includes a decoding means for decoding the key information for use permission, which has been enciphered.

11. A semiconductor integrated circuit according to claim 1, wherein
the use limitation control means is a logic circuit corresponding to the use permission information with a N-bit length,
the output of the logic circuit, when the key information for use permission with a N-bit length is input to the logic circuit, is assumed to be the use limitation release information.

12. A semiconductor integrated circuit according to claim 1, wherein
the functional module with use limitation is controlled according to the key information for use permission which is given from the use limitation control means; and attaches use limitation/release means by which an invalid state is switched to a valid state.

13. A semiconductor integrated circuit according to claim 12, wherein
the use limitation/release means is means by which a control signal or data, which are input to the functional module with use limitation, are made invalid.

14. A semiconductor integrated circuit according to claim 12, wherein
the use limitation/release means is means by which a control signal or data, which the functional module with use limitation outputs, are made invalid.

15. A semiconductor integrated circuit according to claim 12, wherein
the use limitation/release means is means by which power supply to the functional module with use limitation is limited.

16. A semiconductor integrated circuit according to claim 12, wherein
the use limitation/release means is means by which clock supply to the functional module with use limitation is limited.

17. A semiconductor integrated circuit according to claim 1, wherein
the use limitation control means has required idling time in authentication for decision whether the use limitation release information is made valid or not, when the key information for use permission is given from the key information acquisition means.

18. A semiconductor integrated circuit according to claim 1, wherein,
the use limitation control means has the use permission information in common for a plurality of functional modules with use limitation, and
a plurality of the functional modules with use limitation are exclusively made valid.

19. A semiconductor integrated circuit according to claim 1, wherein
the use limitation/release means has required idling time in processing by which the functional module with use limitation is made valid when the use limitation release information is given from the use limitation control means.

20. A semiconductor integrated circuit according to claim 1, wherein
the functional module with use limitation is a timer circuit.

21. A semiconductor integrated circuit according to claim 1, wherein
the functional module with use limitation is a clock generation circuit.

22. A semiconductor integrated circuit according to claim 1, wherein
the functional module with use limitation is a clock switching circuit.

23. A semiconductor integrated circuit according to claim 1, wherein
the functional module with use limitation is a circuit for debugging.

24. A semiconductor integrated circuit according to claim 1, wherein
the functional module with use limitation is a memory.

25. A business method with a semiconductor integrated circuit, comprising the steps of:
providing a semiconductor integrated circuit installing at least one functional module with use limitation to a user;
giving use permission of key information for use permission, which is corresponding to the functional module with use limitation, to the user;
releasing use limitation of the functional module with use limitation, which is corresponding to the key information for use permission, using the key information for use permission to which the use permission is given; and
obtaining consideration for use permission of the key information for use permission from said user.

26 A business method with a semiconductor integrated circuit, comprising the steps of:
providing a semiconductor integrated circuit installing plural kinds of functional modules with use limitation to a user;
giving use permission of key information for use permission, which is corresponding to at least one module among the plural kinds of functional modules with use limitation, to the user;
releasing use limitation of at least one functional module with use limitation corresponding to the key information for use permission, using at least one piece of the key information for use permission to which the use permission has been given; and
obtaining from the user consideration for use permission of the key information for use permission.

27. A business method with a semiconductor integrated circuit, wherein, in a business method with a semiconductor integrated circuit according to claim 26,
at a step of giving use permission of the key information for use permission,
use permission of plural pieces of key information for use permission corresponding to plural kinds of functional modules with use limitation is given;
at a step of releasing the use limitation, use limitation of plural kinds of functional modules with use limitation, which are corresponding to each of plural pieces of key information for use permission, is released using plural pieces of key information for use permission, to which the use permission is given; and
at a step of obtaining the consideration, consideration for use permission of the plural pieces of key information for use permission is configured to be obtained.

28. A business method with a semiconductor integrated circuit, comprising the steps of:
obtaining from a user design information on a function module to be installed in the semiconductor integrated circuit;
providing to the user the semiconductor integrated circuit installing at least one functional module with use limitation based on the obtained design information;
giving use permission of key information for use permission, which is corresponding to the functional module with use limitation, to the user; and
releasing use limitation of the functional module with use limitation corresponding to the key information for use permission, using key information for use permission to which the use permission is given.

29. A business method with a semiconductor integrated circuit, comprising the steps of:
obtaining from a first user design information on a functional module to be installed in the semiconductor integrated circuit;
obtaining from a second user design information on another functional module, which is different from the functional module, to be installed in the semiconductor integrated circuit;
providing to the first user the semiconductor integrated circuit installing plural kinds of functional modules with use limitation, based on each design information which has been obtained from the first and the second users;
providing to the second user a semiconductor integrated circuit with the same specifications with that of the semiconductor integrated circuit;
giving use permission of the first key information for use permission, which is corresponding to the functional module with use limitation based on design information from the first user, to the first user;
releasing, in the first user, use limitation of a functional module with use limitation corresponding to the first key information for use permission, using the first key information for use permission to which the use permission is given;
giving use permission of second key information for use permission, which is corresponding to the functional module with use limitation based on design information from the second user, to the second user; and
releasing, in the second user, use limitation of the functional module with use limitation corresponding to second key information for use permission, using the second key information for use permission, to which said use permission is given.

30. A business method with a semiconductor integrated circuit, a method, using a semiconductor integrated circuit, for electronic commerce between a computer at the side of a provider and a computer at the side of a user through a communications line, comprising the steps of:
transmitting key information for use permission, which is corresponding to a functional module with use limitation, from the computer at the side of the provider to the computer at the side of the user through the communications line; and
receiving the payment information at the computer at the side of the provider, in case that payment information for use of the key information for use permission at the side of the user is transmitted from the computer at the side of the user to the communications line.

31. A business method with a semiconductor integrated circuit according to claim 30, wherein
transmission of the payment information from the computer at the side of the user to the computer at the side of the provider is performed through a financial institution computer which is connected to the communications line.

32. A business method with a semiconductor integrated circuit, a method, using a semiconductor integrated circuit, for electronic commerce between a computer at the side of a provider and a computer at the side of a user through a communications line, comprising the steps of:
receiving the design information at the computer at the side of the provider, in case that the design information on a functional module to be installed on the semiconductor integrated circuit is transmitted from the computer at the side of the user to the computer at the side of the provider through the communications line; and
transmitting key information for use permission, which is corresponding to the functional module with use limitation based on the design information, from the computer at the side of said provider to the computer at the side of the user through said communications line.

33. A business method with a semiconductor integrated circuit, wherein
in a business method with a semiconductor integrated circuit according to any one of claims 25 through 32,
an object semiconductor integrated circuit for the semiconductor integrated circuit comprises:
at least one functional module with use limitation use of which is limited in a state in which use limitation release information is invalid;
key information acquisition means for acquiring key information for use permission in order to make the functional module with use limitation valid;
use limitation control means for use permission by authenticating, based on use permission information which has been held in advance, the key information for use permission given from the key information acquisition means, by making the use limitation release information valid only when authenticated, and by giving the use limitation release information to the functional module with use limitation, and
at a step of releasing the use limitation,
the use limitation control means authenticates the key information for use permission after the key information acquisition means acquires the key information for use permission, the use limitation release information is made valid, and given to the functional module with use limitation only when authenticated, and, thereby, use permission is realized.
